(19) United States
(12) Patent Application Publication
(10) Pub. No.: US 2019/0034564 A1
(43) Pub. Date: Jan. 31, 2019

(54) Nervous System Modeling Tool

(71) Applicant: Fred Narcross, Chengdu (CN)

(72) Inventor: Fred Narcross, Chengdu (CN)

(21) Appl. No.: 15/660,858

(22) Filed: Jul. 26, 2017

(51) Int. Cl. G06F 17/50

(52) U.S. Cl. CPC G06F 17/5009

(57) ABSTRACT

The subject technology is a comprehensive, detailed and accurate reproducer of nervous systems. The technology addresses not only the top-down reality that nervous systems have identifiable organization cytoarchitecturally, which permeates through columnar organization, but also addresses the bottom-up dynamics at the synaptic level of building or pruning of memories according to timing dictates and the metabolic resources supplied and managed by astrocytes and astrocyte networks at the neural vascular unit level. The technology has extremely wide applicability to humanitarian, corporate and private uses.

### TECHNICAL FIELD

The subject technology is in the technical field of modeling nervous systems and their simulation on computing hardware, as well the methods for building the simulations and applying the simulated nervous systems to apparatus which can make use thereof.

### BACKGROUND OF THE INVENTION

The technology's background stems from earlier work in the fields of neuroanatomy, neurophysiology, neurochemistry, biophysics, computational neuroscience and nervous system modeling at the macro and micro levels. The tool presented here is the culmination of research work in the aforementioned fields and results in an integrated top-down and bottom up approach to modeling nervous systems. The scope and scale of this approach supports a here-to-fore unprecedented level of accuracy for modeling nervous systems.

The ability to more accurately model nervous systems, compared to currently available tools, has significant advantages for humanitarian purposes, for corporate efficiencies and for personal use.

On a humanitarian level, accurate nervous system models are practical and useful for reproducing neurological dysfunctions both chronic or suddenly induced from injuries and diseases of the nervous system in general. The latter includes Epilepsy, Alzheimer's and psychiatric debilitations such as depression and bipolar disorder. Reproducing abnormalities as well as modeling recuperative therapies or fixative regimes could save lives, offer improved quality of life or could at least narrow approaches towards those ends.

For corporate endeavors, quasi nervous system models are used today for Big Data analysis. However, and despite the successes, there are significant limitations to the current Big Data state-of-the-art. The Big Data models are time consuming and difficult to set up, require thousands to millions of training trials and are limited to a narrow focus of problem solving. The tool presented here is highly integrated and broad thus expanding the potential to look at multi-dimensional problems. The tool presented here strives for biological accuracy and mimics the brains ability to memorize events from single presentations as well as improvements due to training. Also, the tool does not have to be physically reorganized (recoded) for new problems. Another corporate endeavor where the tool could be useful is the Internet of Things (IoT). Broadly speaking, IoT supports local devices in a working environment, a car or a home, to communicate over an internet or intranet with a common hub application. Current technology, however, often limits the hub to a disparate collection of programs rather than a single integrated system. The technology presented here is integrated and could maximize the efficiency of a disparate IoT approach. Also, on a corporate level the field of robotics is ripe for an integrated control system rather than the current approach which uses a platform of disparate processes. Also, on a corporate level there are considerable monies being spent to attempt to reproduce intelligent decision making. Each of these “intelligent” systems must be programmed with an unending series of modifications required to improve performance. The tool presented here has the capacity to reproduce a human nervous system, which implies the ability to reproduce intelligence with no programming code. The results are obtained through training and the tool's own self-learning.

For personal use, and given that the tool reproduces nervous systems accurately, the tool presented here could mimic human emotions and could strive to keep its owner “happy”. In this regard, the tool could be used as a basis for an advanced personal assistant. The assistant would learn its owners likes, dislikes and habits without having to be programmed for all of these issues separately. It could play music the owner likes and provide new offerings; the same holds true for movies and books. The same could be said for shopping recommendations for food, clothing and entertainment. At home or in the car the assistant could keep the environment suitable for its owner by keeping temperature, humidity and lighting conditions as the owner likes it and according to the season of the year. The assistant could keep the home stocked with the consumables as the owner likes it, could manage appointments and travel logistics. There is no upper limit to what the tool could support: acting like a mother or simply a good friend; premised on the basis that an accurate reproduction of nervous systems can similarly reproduce basic human behaviors. This could also be extremely relevant to the elderly living alone. The assistant could be trained to look for symptoms indicating incapacity, illness or unhappiness and respond accordingly to each of these issues as well as seeking to improve its owner's quality of life.

### BRIEF SUMMARY OF EMBODIMENTS OF THE INVENTION

The subject technology is the most comprehensive, detailed and accurate reproducer of nervous systems available in the public sector. The technology addresses not only the top-down reality that nervous systems have identifiable organization cytoarchitecturally, which permeates through columnar organization, but also addresses the bottom-up dynamics at the synaptic level of building or pruning of memories according to timing dictates and the metabolic resources supplied and managed by astrocytes and astrocyte networks at the neural vascular unit level. The technology has extremely wide applicability to humanitarian, corporate and private uses.

In a variant, a method of generating a computer implemented model of a nervous system comprises placing a small number of interconnected virtual neurons into numbered columns, and into distribution tables of increasing resolution. The method is operable on a system with a processor and a memory, having instructions stored thereon, that when executed cause the processor to carry out the method. Numbered columns are placed in a table of highest resolution, and into connection tables wherein the numbered columns may be joined, and neural vascular units which manage the growth and pruning of neuron synaptic processes.

In another variant of the method, a table of the numbered columns of step (a) is provided, and the types of neurons are identified.

In a further variant, a table of the operational parameters of the neurons of step (a) is provided.

In yet another variant, the connections between the neurons within each numbered column of step (a) are provided.

In still a further variant, the identity of layers within columns is provided.

In a variant, the identity of the location of the neurons from step (a) within the layers is provided.

In another variant, the identity of the location of the axon and the dendrite processes for those neurons within layers is provided.

In a further variant, the method comprise stacking of distribution tables for step (b) wherein three dimensional coordinates are assigned to each of the neurons.

In yet another variant, the calculation of the length of the axon connections for step (c) is provided.

In still a further variant, the method comprises the placement of astrocytes within the neural vascular units.

In a variant, astrocytes are connected into networks.

In another variant, the method further comprises the placement of capillaries within the neural vascular units.

In a further variant, the method comprises the inclusion of dendrites within the neural vascular units.

In yet another variant, the nervous system model's operation is simulated.

In still a further variant, the method includes parallel transfer of all axon signals for all neurons.

In a variant of the method, the dendrite activity is recorded in the form of a tag.

In another variant of the method, the tags indicate that dendrites should grow or be pruned.

In a further variant of the method, growth or pruning is accelerated or decelerated by resources provided by capillaries.

In yet another variant, capillary resources are managed by astrocytes.

In still a further variant, astrocytes open or close capillary resources according to dendrite activity.

In a variant, astrocytes broadcast their activity through the astrocyte network.

In another variant, a method of simulating a nervous system comprises defining columns containing cortical layers, having a dimension in accordance with a user's specification, that contain a collection of neurons of any type. The method comprises generating column definitions, defining neuron connections within the columns, and defining first, second and third 2-dimensional grids. Each grid element of the second grid have a dimension smaller than each grid element of the first 2-dimensional grid, and wherein each of grid element of the third grid have a dimension smaller than grid elements of the second 2-dimensional grid. The method comprises assigning a unique identifier (ID) to each element in the second 2-dimensional grid and organizing the IDs in the first 2-dimensional grid, assigning unique IDs to the grid elements of the third 2-dimensional grid, and organizing the IDs of the third grid under the second 2-dimensional grid. The method comprises assigning unique IDs to the column definitions and organizing the columns within the third 2-dimensional grid with one or more column IDs in each of the grid elements, automatically assigning coordinates in the 2-dimensional grids and assigning a z coordinate of 0 for the first 2-dimensional grid and if multiple first 2-dimensional grids are assigned, then assigning an increment along a z-axis for each additional third 2-dimensional grid.

### BRIEF DESCRIPTION OF THE DRAWINGS

FIG. 1 illustrates 100 Nervous System's basic components all of which the tool is capable of modeling.

FIG. 2 illustrates detail of 106 Cerebral Cortex (CC) and in turn, one of CC's subcomponents, 200 Cerebral Cortex Area 17, is also identified. The Area 17 subcomponent is further detailed by breaking out one of its constituent subcomponents, a cortical column, into a separate entity. All of this detail is modeled by the tool.

FIG. 3 illustrates detail of 201 Cerebral Cortex Area 17 Column. The detail displays neuron types and the layers in which they typically occur; all of which are modeled by the tool.

FIG. 4, 400 Neurons, illustrates a neuron's basic components: soma (the neuron body), apical dendrite (the main dendrite trunk), basal dendrite (dendrite spine clusters), axon trunk (the main axon trunk) and an axon branch (a branch off of the axon trunk), and axon boutons (individual outputs from an axon branch). These basic neuron components are modeled by the tool.

FIG. 5 illustrates the neuron and its subcomponents in different orientations within the context of a cortical column and its layers. The figure also displays different sizes for the axon trunks, apical dendrites and basal dendrites. These different sizes as well as the different orientations within the context of a column are also modeled by the tool.

FIG. 6 illustrates one of the nervous system's basic tenets that neurons are connected. In this figure, a connection between two neurons within a column is illustrated. Neuron connections are modeled by the tool.

FIG. 7 illustrates the basic components of an astrocyte. The astrocyte and its basic components are modeled by the tool.

FIG. 8 illustrates connections between astrocytes. The results form an ever increasing matrix of astrocytes into a network. Astrocyte networks are modeled by the tool.

FIG. 9 illustrates neural vasculature, modeled by the tool, which results in metabolic resources delivered to a neural vascular unit (NVU) via centrioles.

FIG. 10 illustrates an NVU, which serves as the basis for nervous system bottom-up dynamics The NVU is modeled by the tool.

FIG. 11 illustrates how the emulated nervous system is constructed.

FIG. 12 illustrates expanded detail of FIG. 11 showing the system building neurons, astrocytes and the peripheral nervous system as separate processes.

FIG. 13 illustrates expanded detail of FIG. 11 showing the range of the user's design options.

FIG. 14 illustrates expanded detail of FIG. 13 showing how the user's design decisions result in corresponding tables.

FIG. 15 illustrates expanded detail of FIG. 13 showing the different tables included in the category of Connection Tables. Also included in FIG. 15 is expanded detail of FIG. 14's Peripheral Nervous System Buffers and Transducers, and the different tables in the category of Cortical Tables.

FIG. 16 illustrates expanded detail of FIG. 14's System Builds Distribution Tables.

FIG. 17 illustrates expanded detail of FIG. 12 showing the building of the peripheral nervous.

FIG. 18 illustrates expanded detail of FIG. 12's build neurons process.

FIG. 19 illustrates expanded detail of FIG. 12's build astrocytes process.

FIG. 20 illustrates expanded detail of FIG. 18's build neurons process.

FIG. 21 illustrates expanded detail of FIG. 18's connect neurons process.

FIG. 22 illustrates expanded detail of FIG. 21's connect within a column process.

FIG. 23 illustrates expanded detail of FIG. 21's connect intracolumns process.

FIG. 24 illustrates expanded detail of FIG. 21's connect intercolumns process.

FIG. 25 illustrates expanded detail of FIG. 24's connect matrices process.

FIG. 26 illustrates expanded detail of 2208 Connect and Initialize Basal Dendrites referred to by the connect and initialize processes from FIGS. 22, 23, 25, 29 and 30.

FIG. 27 illustrates expanded detail of FIG. 19's build astrocytes process.

FIG. 28 illustrates expanded detail of FIG. 19's connect astrocytes process.

FIG. 29 illustrates expanded detail of FIG. 14's system builds buffers process (for input).

FIG. 30 illustrates expanded detail of FIG. 14's system builds buffers process (for output).

FIG. 31 illustrates expanded detail of FIG. 14's system builds transducers for both input and output.

FIG. 32 illustrates an overview of the update process.

FIG. 33 illustrates expanded detail of FIG. 32 showing the update neurons process.

FIG. 34 illustrates expanded detail of FIG. 32 showing the update astrocytes process.

### DETAILED DESCRIPTION OF THE EMBODIMENTS OF THE INVENTION

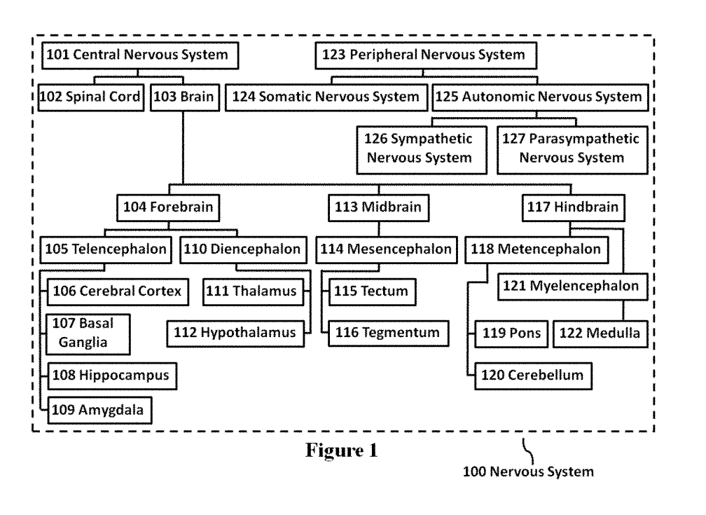

FIG. 1 illustrates 100 Nervous System's basic components. The 100 Nervous System (NS) is divided into two main subcomponents: 101 Central Nervous System (CNS) and 123 Peripheral Nervous System (PNS) which, acting in concert, integrate sensory information and control motor and cognitive functions. The CNS is in turn divided into 102 Spinal Cord (SC) and 103 Brain (brain). The SC is an essential link between the PNS and the brain. In FIG. 1 there is no linkage between the PNS and SC because this is an organization diagram. The brain is the integrative center as well as the highest level control structure of the NS. The brain is subdivided into 104 Forebrain (forebrain), 113 Midbrain (midbrain) and 117 Hindbrain (hindbrain). The forebrain is subdivided into 105 Telencephalon (telencephalon) and 110 Diencephalon (diencephalon). The telencephalon is divided into four components: 106 Cerebral Cortex (CC), responsible for memory and planning and high level motor control and the analysis and classification of sensory systems, 107 Basal Ganglia which is responsible for integrating motor activities between upper level CC control and lower level structures, 108 Hippocampus which is responsible for integrating memory construction, and 109 Amygdala which is responsible for analyzing the emotional context of sensory events in relationship to memories stored and retrieved from CC. The diencephalon is subdivided into two main components: 111 Thalamus which is the sensory systems relay center (except for smell) and the 112 Hypothalamus which serves to monitor and elicit hormones that subserve self-preservation (obtaining sustenance and “fight/flight”) and procreation. Organizationally, the midbrain is also referred to as 114 Mesencephalon and is subdivided into 115 Tectum (tectum) which is responsible for auditory and visual reflexes and 116 Tegmentum (tegmentum) which is concerned with the coordination of sensiomotor information. The hindbrain is divided into three major subdivisions: 118 Metencephalon which is in turn divided into 119 Pons which contains nuclei that relay signals from the forebrain to the cerebellum, along with nuclei that deal primarily with sleep, respiration,swallowing, bladder control, hearing, equilibrium, taste, eye movement, facial expressions, facial sensation, and posture, and 120 Cerebellum which controls movement coordination, balance, equilibrium and muscle tone. The hindbrain's other major subdivisions consist of: 121 Myelencephalon which contains sensory and motor nuclei, projection of sensory and motor pathways, and some cranial nerve nuclei, and 122 Medulla which is responsible for basic life support functions like respiration and heart rate. The entirety of FIG. 1 can be modeled by the tool.

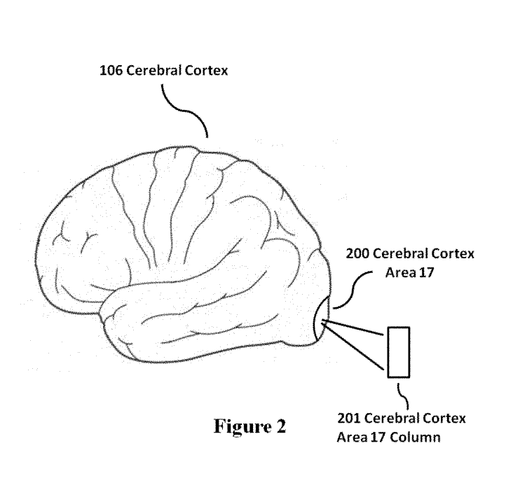

FIG. 2 illustrates further detail of 106 Cerebral Cortex (CC) and in turn, one of CC's subcomponents, 200 Cerebral Cortex Area 17, is also identified. Brodmann subdivided the entirety of CC into 52 distinct areas, numbered from 1 to 52; area 17 is one of these areas. The 200 Cerebral Cortex Area 17 subcomponent is further detailed by breaking out one of its constituent subcomponents, 201 Cerebral Cortex Area 17 Cortical Column, into a separate entity. A cortical column is a construct consisting of neurons interconnected in a columnar organization and considered by many to be the underlying organization of the CC. CC organization by area number and suborganization by columns are modeled by the tool.

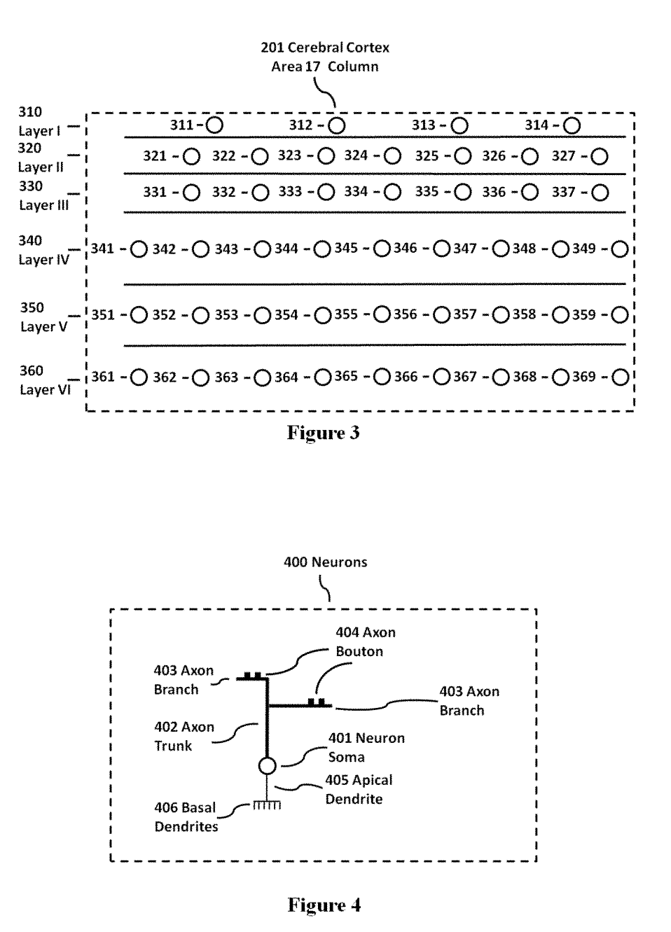

FIG. 3 illustrates further detail of 201 Cerebral Cortex Area 17 Column. The detail displays neuron types and the layers in which they occur. In the CC there are typically 6 layers as displayed in FIG. 3. These layers are numbered with Roman Numerals as is common practice. The neuron numbers per layer are described in further detail in Tables 1-6; and each table corresponds to each of layers I-VI respectively. The neurons in the column and their layer locations are modeled by the tool.

TABLE 1
Neurons in Layer I

| Parameter | Description |
|---|---|
| 311 SB | Single Bouquet Cell |
| 312 NG | Neurogliaform Cell |
| 313 CR | Cajal-Retzius Cell |
| 313 SpS | Spiny Stellate Cell |

TABLE 2
Neurons in Layer II

| Parameter | Description |
|---|---|
| 321 B | Basket Cell |
| 322 M | Martinotti Cell |
| 323 C | Chandelier Cell |
| 324 NGF | Neurogliaform Cell |
| 325 BI | Bipolar Cell |
| 326 SP | Small Pyramidal Cell |
| 327 SS | Spiny Stellate Cell |

TABLE 3
Neurons in Layer III

| Parameter | Description |
|---|---|
| 331 B | Basket Cell |
| 332 M | Martinotti Cell |
| 333 C | Chandelier Cell |
| 334 NGF | Neurogliaform Cell |
| 335 BI | Bipolar Cell |
| 336 SP | Small Pyramidal Cell |
| 337 MP | Medium Pyramidal Cell |

TABLE 4
Neurons in Layer IV

| Parameter | Description |
|---|---|
| 341 B | Basket Cell |
| 342 M | Martinotti Cell |
| 343 C | Chandelier Cell |
| 344 NGF | Neurogliaform Cell |
| 345 BI | Bipolar Cell |
| 346 SP | Small Pyramidal Cell |
| 347 StP | Star Pyramidal Cell |
| 348 SS | Spiny Stellate Cell |
| 349 SmS | Smooth Stellate Cell |

TABLE 5
Neurons in Layer V

| Parameter | Description |
|---|---|
| 351 B | Basket Cell |
| 352 M | Martinotti Cell |
| 353 C | Chandelier Cell |
| 354 NGF | Neurogliaform Cell |
| 355 BI | Bipolar Cell |
| 356 SP | Large Pyramidal Cell |
| 357 T | Triangular Cell |
| 358 F | Fusiform Cell |
| 359 H | Horizontal Cell |

TABLE 6
Neurons in Layer VI

| Parameter | Description |
|---|---|
| 361 B | Basket Cell |
| 362 M | Martinotti Cell |
| 363 C | Chandelier Cell |
| 364 NGF | Neurogliaform Cell |
| 365 BI | Bipolar Cell |
| 366 SP | Medium Pyramidal Cell |
| 367 T | Triangular Cell |
| 368 F | Fusiform Cell |
| 369 H | Horizontal Cell |

FIG. 4, 400 Neurons, illustrates the following components: 401 Neuron Soma (the neuron body), 405 Apical Dendrite (the main dendrite trunk), 406 Basal Dendrite (dendrite spine clusters), 402 Axon Trunk (the main axon trunk), 403 Axon Branch (a branch off of the axon trunk) and 404 Axon Boutons (individual outputs from an axon branch). The 401 Soma is a biological cell and contains a cell's typical compliments of nucleus, membrane, mitochondria etc. The 402 Axon Trunk and 403 Axon Branch and 404 Axon Boutons and 405 Apical Dendrite and 406 Basal Dendrites are the soma's processes. Under appropriate conditions the soma generates an electrical signal which is transmitted down the length of the axon. When the signal reaches the end of the axon at the bouton, neurotransmitters (small quanta of proteins in the form of neurotransmitters) are released and can cross the gap between the axon and the dendrite. The dendrite processes the neurotransmitter by opening or closing channels on the soma's membrane, which supports a change in ionic potential between the interior and exterior of the soma. If the potential is sufficient the soma causes an electrical signal to be transmitted along the length of its axon. FIG. 4's components are modeled by the tool.

FIG. 5 illustrates further detail of 201 Cerebral Cortex Area 17 Column. In this figure the neuron and its subcomponents in different orientations, within the context of a cortical column and its layers, are depicted. The figure also displays different sizes for the 402 Axon Trunks, 405 Apical Dendrites and 406 Basal Dendrites. These different sizes as well as the different orientations within the context of a column are modeled by the tool.

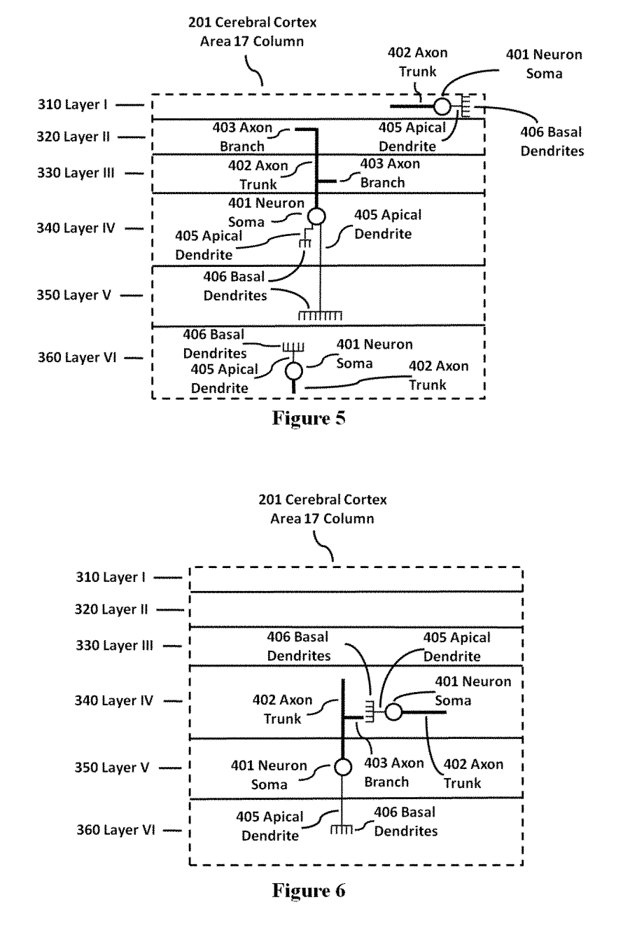

FIG. 6 illustrates further detail of 201 Cerebral Cortex Area 17 Column and displays a basic tenant of a nervous system: neurons are connected which enables communication between one neuron's axons and another neuron's dendrites. In this figure, a connection between two neurons within a column is illustrated. Neuron connections are modeled by the tool.

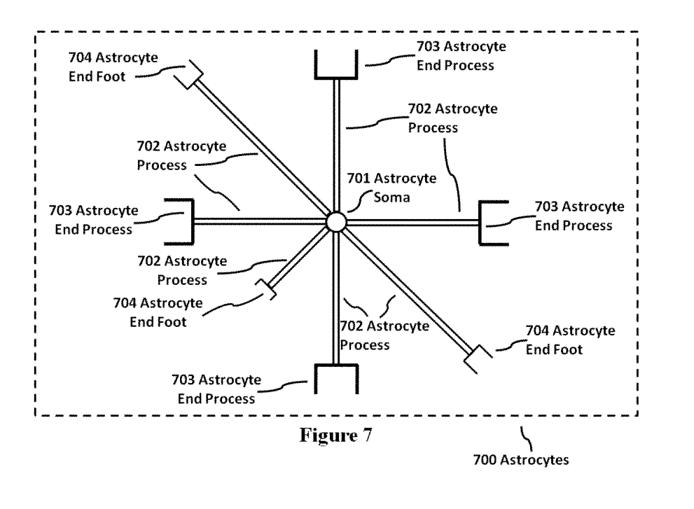

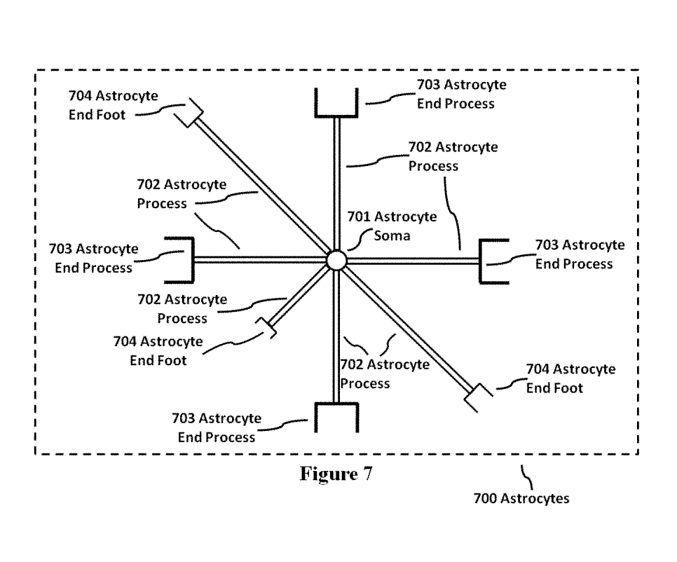

FIG. 7, 700 Astrocytes, illustrates the basic components of an astrocyte. Included in the figure are 701 Astrocyte Soma (the astrocyte cell body), 702 Astrocyte Process (the soma appendage for communication), 703 Astrocyte End Process (a gap junction between astrocytes for astrocyte to astrocyte communication) and 704 Astrocyte End Foot (a junction from the appendage to the vasculature's endothelium—an interface which controls blood flow). Astrocytes and their basic components are modeled by the tool.

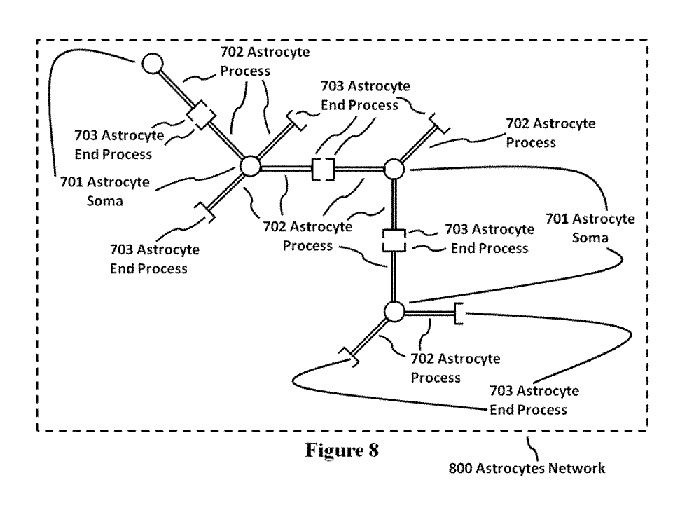

FIG. 8, 800 Astrocytes Network, illustrates connections between astrocytes. The results form an ever increasing matrix of astrocytes into a network measured by the thousands and greater. Shown here are 701 Astrocyte Soma, 702 Astrocyte Process and 703 Astrocyte End Process. 703, using gap junctions, permits astrocytes to communicate the activity of the neurons, which they surround, to coupled astrocytes in the astrocyte network. Astrocyte networks are modeled by the tool.

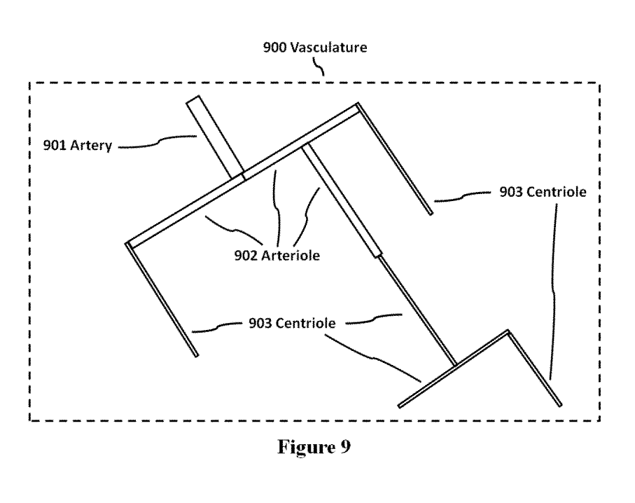

FIG. 9, 900 Vasculature, illustrates vasculature (blood vessels), which delivers glucose, oxygen, nutrients, hormones and other substances required for normal nervous system (neuron) function. In the figure, the main contributing structure is 901 Artery which branches into smaller “pipes” 902 Arteriole. 902 branches into smaller “pipes”, 903 Centrioles, which are small enough to only permit the passing of molecules (nutrients) and individual blood cells for example red blood cells to supply oxygen. This smallest level of branching is necessary to deliver components to the brain's vast microarchitecture like somas, astrocytes and synapses. All of these vasculature components are modeled by the tool.

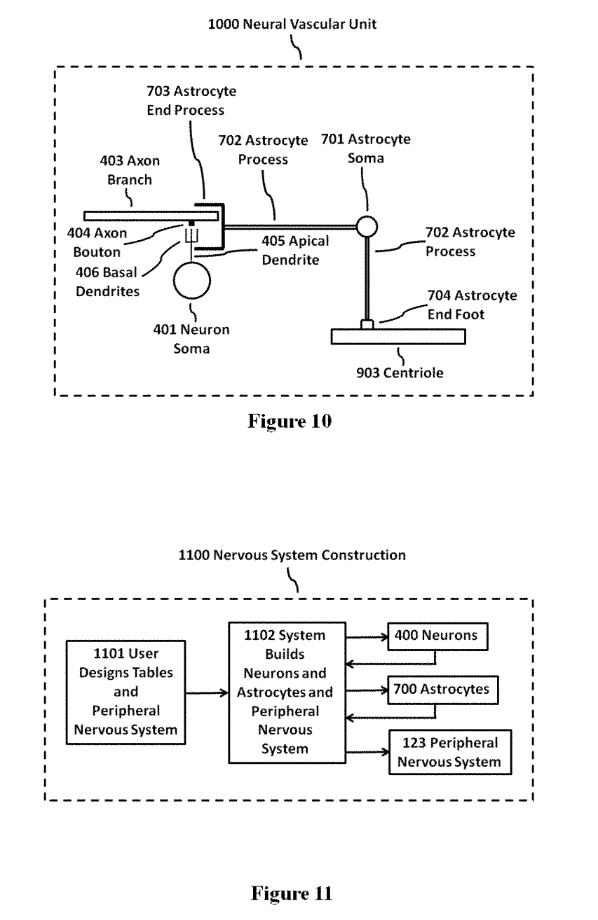

FIG. 10, 1000 Neural Vascular Unit, illustrates a neural vascular unit (NVU), which serves as the basis for a nervous system's bottom-up dynamics The dynamics couple neuronal activity and corresponding metabolic resource demand with astrocytes' management of vasculature resources to supply the demand or conversely to restrict resource supply when demand is low or anti-correlated with synaptic activity. The net effect is to optimize cerebral blood flow which on average represents 20% of a human body's total resource demands despite the fact that the human brain represents only about 2% of total body weight. The figure shows the coupling of the 701 Astrocyte Soma through its 702 Astrocyte Process and out to its 703 Astrocyte End Process. 703 surrounds the 403 Axon Branch and its 404 Axon Bouton which, in turn, couple to 406 Basal Dendrites that communicate through the 405 Apical Dendrite to the 401 Neuron Soma. This juncture between 404 and 406 communicates the juncture's activity back through 703 and hence to 701. 701 connects through another 702 Process to 704 Astrocyte End Foot that is directly attached to 903 Centriole. 903, in turn, can dilate upon 701's demand request and supply greater resources to the whole of 401 through 405 and then to 406. The net effect is to supply 406 with resources that support growth and hence strengthening of the synaptic connection to 404. Strengthening in this case is also related to the timing between the axon transmission and the receiving soma response; collectively known as spike timing dependent plasticity (STDP). Under conditions of negative correlations 701 can cause 903 restriction and thus prevent growth to the point that 406 is pruned of its transmission capacity. NVUs are modeled by the tool.

FIG. 11, 1100 Nervous System Construction, illustrates how the emulated NS is constructed. First, the user designs the specifics of the NS in the form of 1101 User Designs Tables and Peripheral Nervous System, which quantify the specifics of the NS and includes the tool's buffers and transducers to simulate the PNS. With those specifics 1102 System Builds Neurons and Astrocytes and Peripheral Nervous System creates and initializes and connects 400 Neurons (neurons), 700 Astrocytes (astrocytes) and 123 Peripheral Nervous System (PNS). 400, 700 and 123 are the primary components of the emulated nervous produced by the tool.

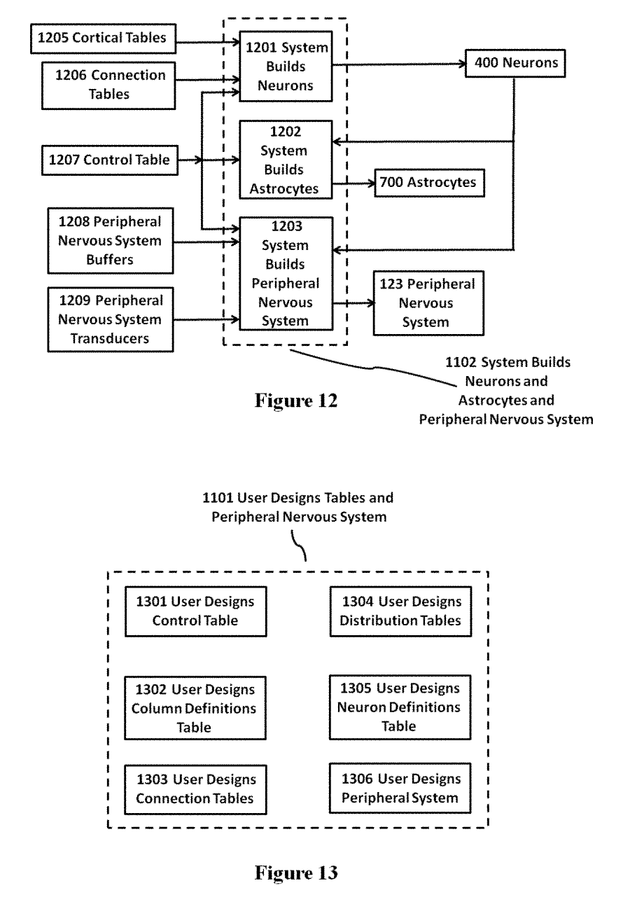

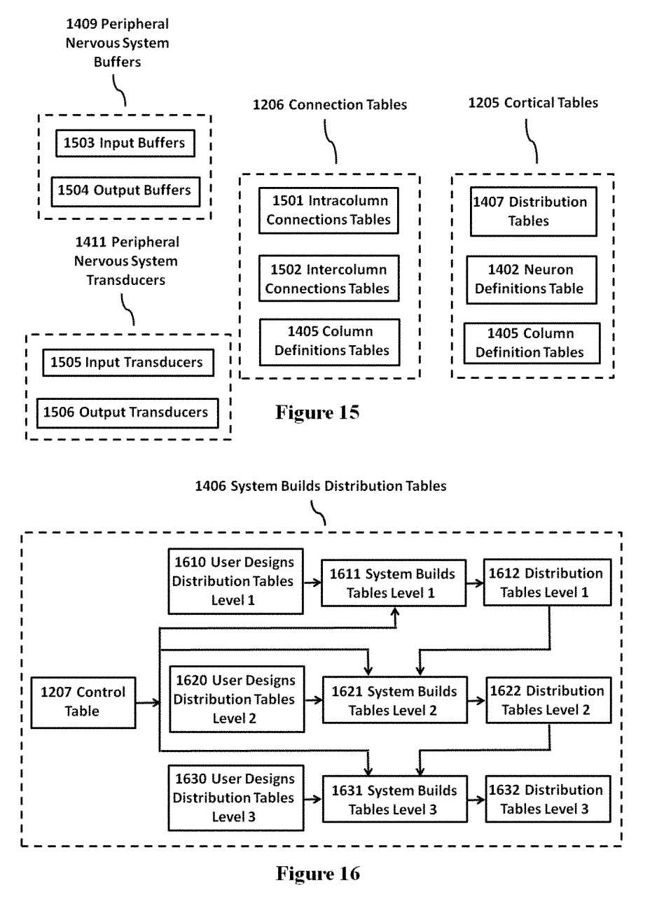

FIG. 12, 1102 System Builds Neurons and Astrocytes and Peripheral Nervous System, illustrates expanded detail of FIG. 11 and shows 1201 System Builds Neurons which builds neurons, 1202 System Builds Astrocytes which builds astrocytes, and 1203 System Builds Peripheral Nervous which builds the PNS. 1201 takes as its input 1205 Cortical Tables (shown in FIG. 15), 1206 Connection Tables (shown in FIG. 15) and 1207 Control Table (Table 7). 1201 produces 400 Neurons as its output. 1202 takes as its input 1207 and 400 and produces as its output 700 Astrocytes. 1203 takes as its input 1208 Peripheral Nervous System Buffers and 1209 Peripheral Nervous System Transducers and 1207 and 400. 1203 produces as its output 123 Peripheral Nervous System.

TABLE 7
Control Table

| Parameter | Description |
|---|---|
| 120701 astrocyteArrayFileName | Astrocyte file name for input |
| 120702 astrocyteArrayFileNameUpdate | Astrocyte file name for output |
| 120703 neuronArrayFileName | Neuron file name for input |
| 120704 neuronArrayFileNameUpdate | Neuron file name for output |
| 120705 astrocyte | Astrocyte array |
| 120706 neuron | Neuron array |
| 120707 columnID | Current column ID |
| 120708 neuronID | Current neuron ID |
| 120709 astrocyteID | Current astrocyte ID |
| 120710 pnsInputBuffer | PNS input buffer array |
| 120711 pnsInputNeuronIDs | PNS input buffer array neuron IDs |
| 120712 pnsDefs | PNS target designations |

| | |
|---|---|
| 12071201 pnsDefsLev1ID | Distribution Table Level 1 ID |
| 12071202 pnsDefsLev2ID | Distribution Table Level 2 ID |
| 12071203 pnsDefsLev3ID | Distribution Table Level 3 ID |
| 12071204 pnsDefsType | Neuron type |
| 12071205 pnsDefsType | Percentage |

| | |
|---|---|
| • | • |

| | |
|---|---|
| 120713 run type | Run type = new, read only, update |
| 120714 DT1_X | Number of rows in Distribution Table 1 |
| 120715 DT1_Y | Number of columns in Distribution Table 1 |
| 120716 DT2_X | Number of rows in Distribution Table 2 |
| 120717 DT2_Y | Number of columns in Distribution Table 2 |
| 120718 DT3_X | Number of rows in Distribution Table 3 |
| 120719 DT3_Y | Number of columns in Distribution Table 3 |
| 120720 DT1_Size | Size of Distribution Table 1 in mm |
| 120721 DT2_Size | Size of Distribution Table 2 in mm |
| 120722 DT3_Size | Size of Distribution Table 3 in mm |
| 120723 DT_Z_Size | Distribution Table s' Z dimension in mm |
| 120724 Myelinated Velocity | Velocity of myelinated axon in mm/ms |
| 120725 Unmyelinated Velocity | Velocity of unmyelinated axon in mm/ms |
| 120726 PNSName | Name for this PNS modality |
| 120727 PNSDistTable1# | Column # in Distribution Table 1 |
| 120728 PNSDistTable2# | Column # in Distribution Table 2 |
| 120729 PNSDistTable3# | Column # in Distribution Table 3 |
| 120730 PNSType | Modality Type - input or output |
| 120731 PNSNeuron Type | Modality Neuron Type |
| 120732 PNSConnection % | % of basal dendrite connections |

| | |
|---|---|
| • | • |

| | |
|---|---|
| 1207XX PNSName | Name for this PNS modality |

| | |
|---|---|
| • | • |

FIG. 13 illustrates expanded detail of FIG. 11 showing the range of the user's design options. Because the tool provides broad and deep control on the operating characteristics of the resultant emulated nervous system 1101 requires the user to spend time researching the goals of the user's particular nervous system design and how it is to be accomplished. The more sophisticated the nervous system to be emulated the more time 1101 requires. That said, the tool is not restricted to actual biological systems. The emulated nervous system could be “based on” biological systems and utilized for Big Data analysis only and thus the design effort could be greatly simplified. Design options include 1301 User Designs Control Table, 1302 User Designs Column Definition Tables, 1303 User Designs Connection Tables, 1304 User Designs Distribution Tables, 1305 User Designs Neurons Definitions Table and 1306 User Designs Peripheral System. It is notable that once a design is completed that all or parts are reusable, which permits progression from simpler to more complex systems in a step-wise fashion with a minimum of changes between design steps.

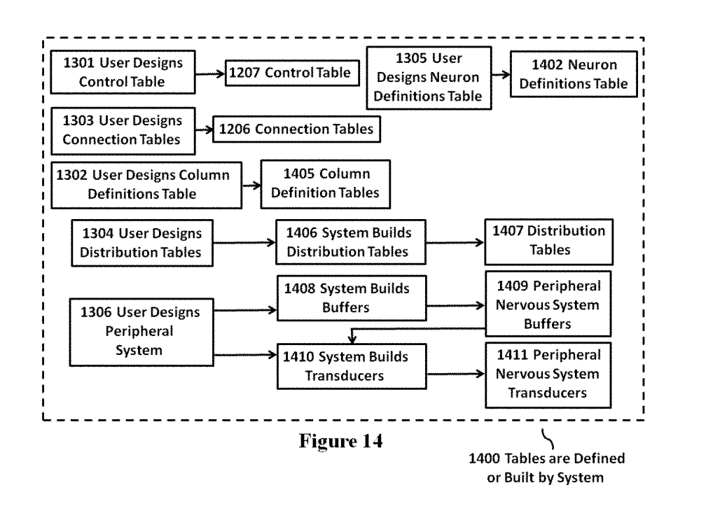

FIG. 14, 1400 Tables are Defined or Built by System, illustrates expanded detail of FIG. 13 showing how the user's design decisions result in corresponding tables as well as which tables require system intervention in order to be completed. 1400 begins with 1301 User Designs Control Table, which results directly in the completion of 1207 Control Table (Table 7). Similarly, 1303 User Designs Connection Tables results directly in 1206 Connection Tables (illustrated in FIG. 15). 1305 User Designs Neuron Definitions Table results directly in 1402 Neuron Definitions Table (illustrated in Table 12) and 1302 User Designs Column Definitions Table results directly in 1405 Column Definition Tables (illustrated in Table 11). 1304 User Designs Distribution Tables requires the tool's intervention to fill in parameters in the tables and this process is accomplished by 1406 System Builds Distribution Tables which results in 1407 Distribution Tables (illustrated in Tables 8, 9 and 10). 1306 User Designs Peripheral System requires two system processes: 1408 System Builds Buffers, which results in 1409 Peripheral Nervous System Buffers, and 1410 System Builds Transducers, which together with 1409 results in 1411 Peripheral Nervous System Transducers.

TABLE 8
Distribution Table Level 1

| Parameter | Description |
|---|---|
| 16121 dTableLevel1Layer1 | Distribution table level 1 |

| | |
|---|---|
| 1612110 level1Layer1Row1 | Layer 1 row1 |

| 1612111 level1Layer1Row1Column1 | | Layer 1 row1, column1 |
|---|---|---|
| 1612111A level1Layer1Row1Column1# | | Layer 1 row1, column1, column # |
| 1612112 level1Layer1Row1Column2 | | Layer 1 row1, column2 |
| 1612112A level1Layer1Row1Column2# | | Layer 1 row1, column2, column # |
| | • | • |
| | • | • |

| | |
|---|---|
| 1612120 level1Layer1Row2 | Layer 1 row2 |

| 1612121 level1Layer1Row2Column1 | | Layer 1 row2, column1 |
|---|---|---|
| 1612121A level1Layer1Row2Column1# | | Layer 1 row2, column1, column # |
| 1612122 level1Layer1Row2Column2 | | Layer 1 row2, column2 |
| 1612122A level1Layer1Row2Column2# | | Layer 1 row2, column2, column # |
| | • | • |
| | • | • |

| | |
|---|---|
| 16122 dTableLevel1Layer2 | Layer 2 row1 |

| | |
|---|---|
| • | • |
| • | • |

| | |
|---|---|
| • | • |
| • | • |

TABLE 9
Distribution Table Level 2

| Parameter | Description |
|---|---|
| 16221 dTableLevel2Layer1 | Distribution table level 2 |

| | |
|---|---|
| 1622110 level2Layer1Row1 | Layer 1 row1 |

| 1622111 level2Layer1Row1Column1 | | Layer 1 row1, column1 |
|---|---|---|
| 1622111A level2Layer1Row1Column1# | | Layer 1 row1, column1, column # |
| 1612112 level2Layer1Row1Column2 | | Layer 1 row1, column2 |
| 1622112A level2Layer1Row1Column2# | | Layer 1 row1, column2, column # |
| | • | • |
| | • | • |

| | |
|---|---|
| 1622120 level2Layer1Row2 | Layer 1 row2 |

| 1622121 level2Layer1Row2Column1 | | Layer 1 row2, column1 |
|---|---|---|
| 1622121A level2Layer1Row2Column1# | | Layer 1 row2, column1, column # |
| 1622122 level2Layer1Row2Column2 | | Layer 1 row2, column2 |
| 1622122A level2Layer1Row2Column2# | | Layer 1 row2, column2, column # |
| | • | • |
| | • | • |

| | |
|---|---|
| 16222 dTableLevel2Layer2 | Layer 2 row1 |

| | |
|---|---|
| • | • |
| • | • |

| | |
|---|---|
| • | • |
| • | • |

TABLE 10
Distribution Table Level 3

| Parameter | Description |
|---|---|
| 16321 dTableLevel3Layer1 | Distribution table level 3 layer 1 |

| | |
|---|---|
| 1632110 level3Layer1Row1 | Layer 1 row1 |

| | |
|---|---|
| 1632111 level3Layer1Row1Column1 | Layer 1 row1, column1 |

| | |
|---|---|
| 1632111A level3Layer1Row1Column1# | Layer 1 row1, column1, column # |
| 1632111B leve3Layer1Row1Column1ID | Layer 1 row1, column1, column ID |
| 1632111C level3Layer1Row1Column1Coord | Layer 1 row1, column1, column coord |

| | |
|---|---|
| 1632112 level3Layer1Row1Column2 | Layer 1 row1, column2 |

| | |
|---|---|
| 1632112A level3Layer1Row1Column2# | Layer 1 row1, column2, column # |
| 1632112B level3Layer1Row1Column1ID | Layer 1 row1, column1, column ID |
| 1632112C level3Layer1Row1Column1Coord | Layer 1 row1, column1, column coord |

| | |
|---|---|
| • | • |

| 1632210 level3Layer1Row1 | | Layer 1 row2 |
|---|---|---|
| | • | • |

| | |
|---|---|
| 16322 dTableLevel3Layer2 | Distribution table level 3 layer 2 |
| • | • |

TABLE 11
Column Definitions Tables

| Parameter | Description |
|---|---|
| 140501 columnNumber01 | Column number 01 |

| | |
|---|---|
| 1405011 Layer 1 | Layer 1 entries begin |

| | |
|---|---|
| 140501101 neuronTypeLayer 1 | Neuron type in layer 1 connect to |

| | |
|---|---|
| 140501101A neuronAlloc# | Number of neurons to allocate |
| 140501101B1 neuronApicalDendriteLayer 1 | Apical dendrite in layer 1 (if any) |
| 140501101C1 neuronSyn# | Number of synapses to allocate |

| | |
|---|---|
| 140501101D101A neuronTypeFrom | Neuron type connect from |
| 140501101D101B neuronAlloc% | % of clusters to connect |
| 140501101D102A neuronTypeFrom | Neuron type connect from |
| 140501101D102B neuronAlloc% | % of clusters to connect |

| | |
|---|---|
| • | • |

| 140501101B2 neuronApicalDendriteLayer 2 | | Apical dendrite in layer 2 (if any) |
|---|---|---|
| | • | • |

| | |
|---|---|
| • | • |

| 140501102 neuronTypeLayer 1 | | Neuron type in layer 1 connect to |
|---|---|---|
| | • | • |
| 1405012 Layer 2 | | Layer 2 entries begin |
| | • | • |

| | |
|---|---|
| 140502 columnNumber02 | Column number 02 |
| • | • |

TABLE 12
Neuron Definitions Table

| Parameter | Description |
|---|---|
| 140201 neuronType 01 | Neuron type designation number |

| | |
|---|---|
| 14020101 neuronVoltage | Neuron's voltage value |
| 14020102 neuronCurrent | Neuron's current value |
| 14020103 neuronCapillary | Neuron's capillary value |
| 14020104 neuronSTDP decay | Neuron's STDP short term decay |
| 14020104 neuronParameter 1 | Neuron's parameter 1 value |
| 14020105 neuronParameter 2 | Neuron's parameter 2 value |
| 14020106 neuronParameter 3 | Neuron's parameter 3 value |

| | |
|---|---|
| • | • |

| | |
|---|---|
| 14020107A neuronADNMDAValue | Neuron apical dendrite NMDA value |
| 14020107B neuronADGABAValue | Neuron apical dendrite GABA value |
| 14020107C neuron ADAcetylcholineValue | Neuron apical dendrite acetylcholine value |
| 14020107D neuronADDopamineValue | Neuron apical dendrite dopamine value |
| 14020107E neuronADVoltageValue | Neuron apical dendrite voltage value |
| 14020107F neuronADCurrentValue | Neuron apical dendrite current value |

| | |
|---|---|
| 14020108A neuronBDSTDPShort | Neuron basal dendrite short term STDP |
| 14020108B neuronBDSTDPLong | Neuron basal dendrite long term STDP |
| 14020108C neuronBDFromExcitatory | Neuron basal dendrite excitatory - yes/no |

| | |
|---|---|
| 140202 neuronType 02 | Neuron type designation number |
| • | • |

TABLE 15
Input Buffers

| Parameter | Description |
|---|---|
| 150301A bufferName1 | Name for input buffer 1 |
| 150301B bufferName1Value | Value for input buffer 1 |
| 150301C bufferName1IDs | Neuron IDs to receive buffer 1 values |

| | |
|---|---|
| • | • |

| | |
|---|---|
| 150302A bufferName2 | Name for input buffer 2 |

| | |
|---|---|
| • | • |

FIG. 15 illustrates expanded detail of FIG. 13 showing the different tables included in the category of 1206 Connection Tables. These include 1501 Intracolumn Connection Tables (detailed in Table 14 and relates how neighboring columns should connect to each other) and 1502 Intercolumn Connection Tables (detailed in Table 13 and relates how columns at a distance should connect to each other) and 1405 Column Definition Tables (detailed in Table 11). 1405 serves two basic purposes: one it relates what neurons and their multiples exist in a particular column at which layers and second it relates how those neurons are connected within the column. Also included in FIG. 15 is expanded detail of FIG. 14's Peripheral Nervous System Buffers and Transducers. 1409 Peripheral Nervous System Buffers includes both 1503 Input Buffers (illustrated in Table 15) and 1504 Output Buffers (illustrated in Table 16). 1411 Peripheral Nervous System Transducers includes both 1505 Input Transducers (information in Table 17) and 1506 Output Transducers (information in Table 18). 1505 is user code to translate non-neural data into a neural (digital form) for related 1503 input buffers. 1506 is user code to translate non-neural data into a neural (digital form) for related 1504 output buffers. Finally, FIG. 15 illustrates the different tables included in the category of 1205 Cortical Tables. This includes 1407 Distribution Tables (illustrated in Tables 8, Table 9 and Table 10), 1402 Neuron Definitions Table (illustrated in Table 12) and 1405 Column Definitions Tables (illustrated in Table 11).

TABLE 13
Intracolumn Connections Tables

| Parameter | Description |
|---|---|
| 150101A dTableLevel1 | dTableLevel1 value from |
| 150101B dTableLevel2 | dTableLevel2 value from |
| 150101C dTableLevel3 | dTableLevel3 value from |
| 150101D neuronTypeFrom | Neuron type designation number from |
| 150101E neuronTypeTo | Neuron type designation number to |
| 150101F neuronAlloc% | % of basal dendrites to connect |
| 150102A dTableLevel1 | dTableLevel1 value from |
| 150102B dTableLevel2 | dTableLevel2 value from |
| 150102C dTableLevel3 | dTableLevel3 value from |
| 150102D neuronTypeFrom | Neuron type designation number from |
| 150102E neuronTypeTo | Neuron type designation number to |
| 150102F neuronAlloc% | % of basal dendrites to connect |

| | |
|---|---|
| • | • |

TABLE 14
Intercolumn Connections Tables

| Parameter | Description |
|---|---|
| 150201A dTableLevel1 | dTableLevel1 value from |
| 150201B dTableLevel2 | dTableLevel2 value from |
| 150201C dTableLevel3 | dTableLevel3 value from |
| 150201D neuronType | Neuron type designation number from |
| 150201E orientationType | Connection Orientation - top/bottom, |
| | left/right |
| 150201F connectionDensity | Density of connections - equal, sparse, dense |
| 15020101A dTableLevel1 | dTableLevel1 value to |
| 15020101B dTableLevel2 | dTableLevel2 value to |
| 15020101C dTableLevel3 | dTableLevel3 value to |
| 15020101D neuronType | Neuron type designation number to |
| 15020101E neuronAlloc% | % of basal dendrites to connect |
| 15020102A dTableLevel1 | dTableLevel1 value to |
| 15020102B dTableLevel2 | dTableLevel2 value to |
| 15020102C dTableLevel3 | dTableLevel3 value to |
| 15020102D neuronType | Neuron type designation number to |
| 15020102E neuronAlloc% | % of basal dendrites to connect |

| | |
|---|---|
| • | • |

| | |
|---|---|
| 150202A dTableLevel1 | dTableLevel1 value from |

| | |
|---|---|
| • | • |

TABLE 16
Output Buffers

| Parameter | Description |
|---|---|
| 150401A bufferName1 | Name for output buffer 1 |
| 150401B bufferName1Value | Value for input buffer 1 |
| 150401C bufferName1IDs | Neuron IDs to send buffer 1 values |

| | |
|---|---|
| • | • |

| | |
|---|---|
| 150402A bufferName2 | Name for output buffer 2 |

| | |
|---|---|
| • | • |

TABLE 17
Input Transducer Information

| Parameter | Description |
|---|---|
| 150501 transducerName1 | Name of transducer for input buffer 1 |
| 150502 transducerName2 | Name of transducer for input buffer 2 |

| | |
|---|---|
| • | • |
| • | • |
| • | • |

FIG. 16 illustrates expanded detail of FIG. 14's 1406 System Builds Distribution Tables. The distribution tables organize the emulated nervous system in a top-down manner of granularity as well as supporting a general coordinate system for neurons, astrocytes and their corresponding processes. The user designs the granularity and the system supplies the coordinates. Coordinates are used to establish which astrocyte should surround particular neurons as well as establishing which astrocytes should be connected to other astrocytes in an astrocyte network. The distribution tables are organized into 3 levels of granularity and within each level are layers and each layer represents a measurement difference of 1207 Control Table (Table 7) parameter 120723 which defaults to 5 mm but can be modified by the user. This scheme supports a realistic breadth and depth of a human nervous system from cerebral cortex to spinal cord. At the highest level of granularity the user designs the level 1 tables (layers): 1610 User Designs Distribution Tables Level 1. Each Level 1 distribution table layer is defined by the user to be a 20 by 20 matrix of cells each of which might contain a number representing a cytoarchitectural area of 100 mm² (default) or contains a 0 for no area. The user can assign numbers from the standard literature, e.g. Brodmann, or of the user's creation. Numbers may be duplicated to expand the size of a particular cytoarchitectural area. The approach supports a default of up to 40,000 mm² per Level 1 layer and, due to multiple layers in Level 1, supports a human brain's cortical surface area of 232,257.5 mm². 1611 System Builds Tables Level 1 uses input from 1207 Control Table and the 1610 design in order to build 1612 Distribution Tables Level 1. 1207 supplies parameters 120714 and 120715 which specify the number of rows and columns in the user's design (defaults are 20 by 20), 1207 also supplies parameter 120720 which supplies the dimensions in mm² of each cell. The last design parameter for 1610 is that if the user specifies a positive number in a Level 1 cell then the system will automatically create a complete Level 2 table with that same number. Otherwise, if the user enters a negative number then the system will go to that layer number in Level 2 for further details. This approach allows the user to default a complete Level 2 table layer or to further customize a Level 2 table to a non-default size or to have a collection of different sub-numbers in a Level 2 layer. 1621 System Builds Tables Level 2 is the next level of granularity at the user's disposal. By default it consists of a 13 by 13 matrix of cells but can be modified by the user with 1207's parameters 120716 and 120717 to have a different number of rows and columns respectively, each of which represents a default area of 0.769 mm² but can be modified to a different measure with 120721. In each Level 2 layer matrix the user supplies a number reflective of standard literature or of the user's choosing. All of this is pursued if a Level 1 layer number was negative; otherwise the system fills out a level 2 layer based upon the number supplied by the user in level 1. And as in Level 1, if the user specifies a positive number then the system will automatically fill out a level 3 table with those numbers. Otherwise, if the number is negative then the system will seek out the number in level 3. Finally, the user designs the Level 3 tables when a previous negative value was supplied in a level 2 layer: 1630 User Designs Distribution Tables Level 3. Each layer in level 3 is a matrix of 13 by 13 cells (default) which can be modified to different row and column dimensions using 1207's parameters 120718 and 120719 respectively. At Level 3, each cell is intended to represent a column of neurons and the number entered into a Level 3 layer matrix (automatically or by the user) represents an entry into Table 11 Column Definition Tables to designate what column should be present at this level (represented by parameters with numbering convention 140501, 140502, etc. in Table 11). The default cell dimensions are 0.059 mm² but can be modified by 1207's parameter 120722. Each non-zero cell receives coordinates as represented by Table 10's parameters with an “C” prefix, e.g. 132111C and 1632112C. Coordinates are calculated by the row and column and layer of Table 10 by using parameters 120718, 120719, 120723 from Table 7. Each non-zero cell also receives a unique ID, beginning with “1”, as represented by Table 10's parameters with an “B” prefix, e.g. 132111B and 1632112B. Finally, Each non-zero cell also receives the column number as represented by Table 10's parameters with an “A” prefix, e.g. 132111A and 1632112A. The column number is either inserted by the user when a negative number was entered into the higher level cell of Level 2 or the system fills out the entire Level 3 table when the user's Level 2 entry was positive. The tables and their layers that result from 1406 can cytoarchitecturally represent cortex or subcortex as displayed in FIG. 1.

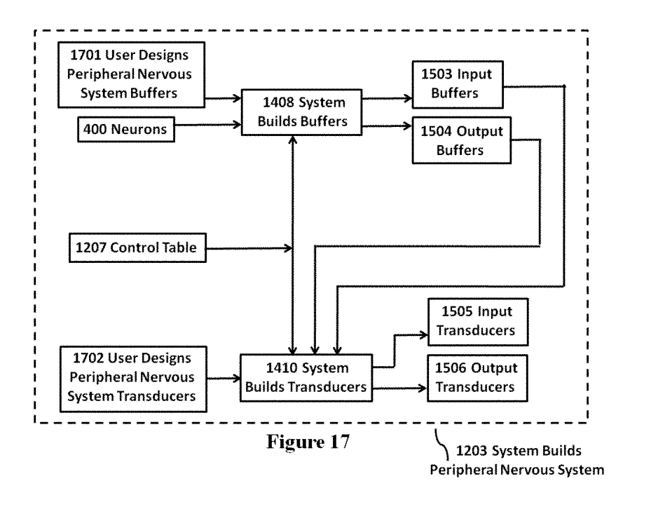

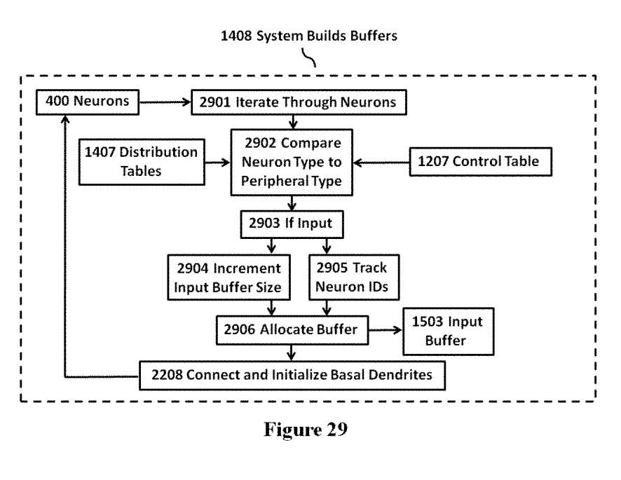

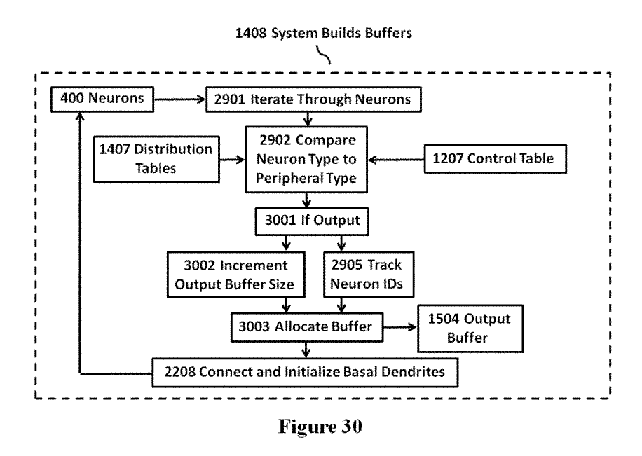

FIG. 17 illustrates expanded detail of FIG. 12 1203 System Builds Peripheral Nervous System, showing the building of the peripheral nervous system (PNS). The PNS consists of two parts that are unlike the rest of the emulated nervous system and simulate the nervous system's actions by using computer concepts of buffers and transducers. The input transducers interface to non-neural components like vision, audition and hormones and convert the components' values into neural signals. The signals are placed into buffers and the buffers' values interface to dendrites. On the other hand, axon signals, destined to activate non-neural components, are buffered for output and then translated by output transducers into a form suitable for the component, e.g. actuators for muscle-like processes or for the generation of hormones. 1408 System Builds Buffers is detailed in full in FIGS. 28 and 29. In FIG. 17, 1408 accepts input from 1701 User Designs Peripheral Nervous System Buffers, 400 Neurons, and from 1207 Control Table. In 1701 the user must decide what buffers to include, their sizes and where they are transmitting to and from; and together with 400 and 1207, 1408 builds input buffers (1503 Input Buffers) and builds output buffers (1504 Output Buffers). 1410 System Builds Transducers is detailed in FIG. 30. In FIG. 17, 1410 accepts input from 1702 User Designs Peripheral Nervous System Transducers, from 1503 and 1504, and from 1207. In 1702 the user must design code (preferably in Java—the language of the tool) which translates neural signals from axons to output “devices” like actuators or must translate non-neural signals into neural signals suitable for input to dendrites. 1503 and 1504 serve to delineate to the transducers the number and sizes of requisite input and output buffers that the user's code must interface. 1410 results in 1505 Input Transducers and 1506 Output Transducers (Tables 17 and 18 respectively).

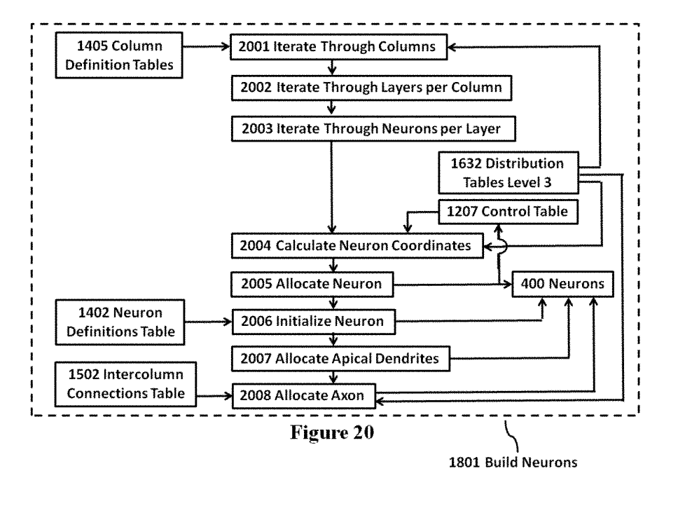

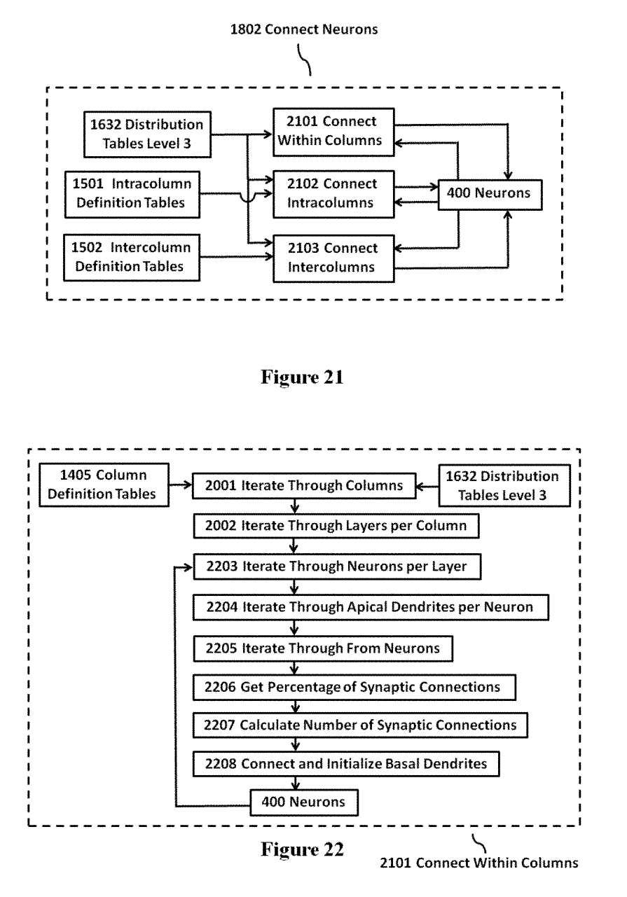

FIG. 18 illustrates expanded detail of FIG. 12, 1201 System Builds Neurons, showing both the high level building and connection of neurons. These two processes are detailed further in FIGS. 20 and 21. In FIG. 18, 1801 Build Neurons takes as input 1507 Cortical Tables, 1207 Control Tables and 1632 Distribution Tables Level 3. 1801 then generates 400 Neurons. The neurons must then be connected and this is accomplished by 1802 Connect Neurons. 1802 takes as input 400 and 1303 Connection Tables. 1802's output is the linkage between neurons in 400.

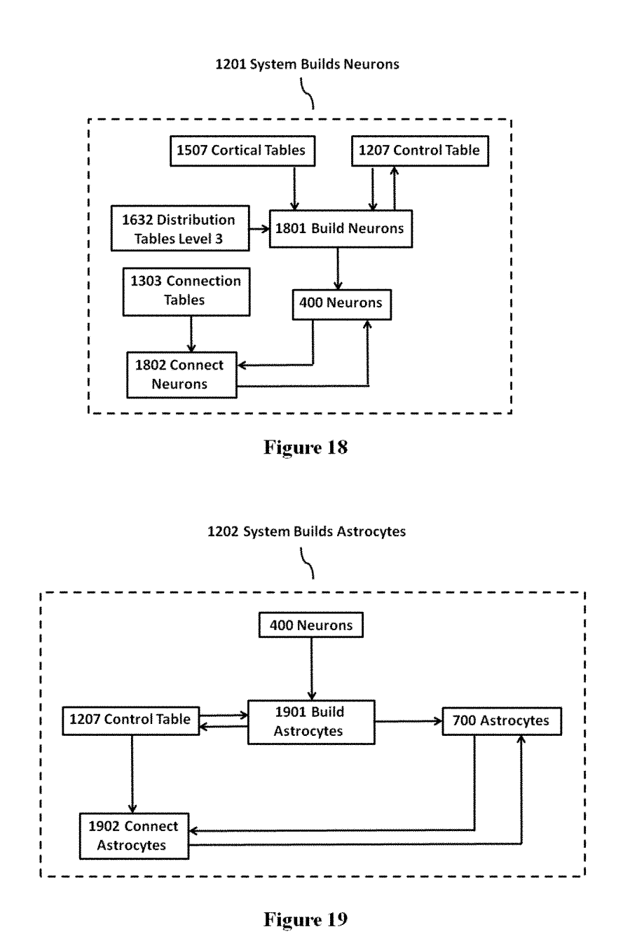

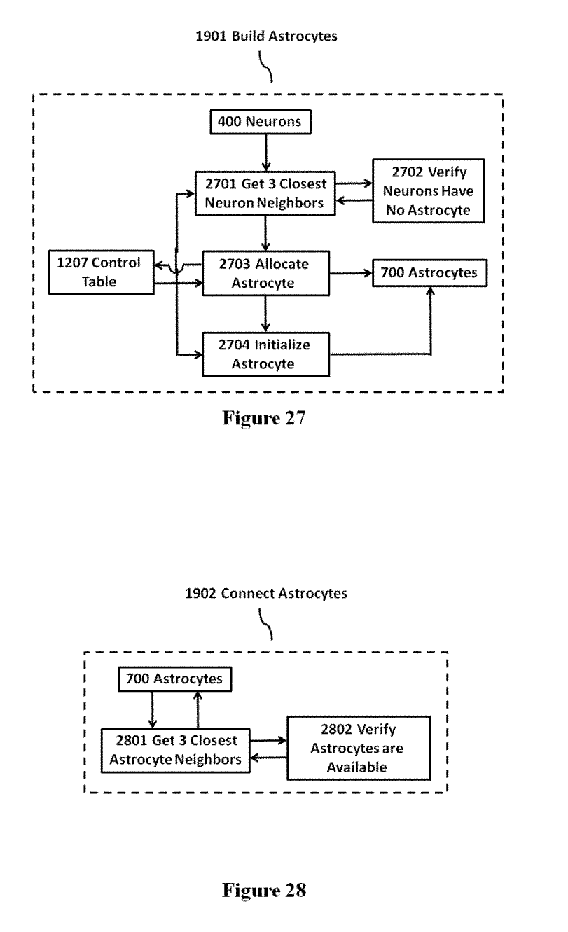

FIG. 19 illustrates expanded detail of FIG. 12, 1202 System Builds Astrocytes, showing both the building and connection of astrocytes. These two processes are detailed further in FIGS. 26 and 27. In FIG. 19, 1901 Build Astrocytes, takes as its input 400 Neurons and 1207 Control Table and produces output of 700 Astrocytes. 1902 Connect Astrocytes takes as input 700 and 1207. 1902's output is the linkage between astrocytes in 700, which culminates in an astrocyte network represented by connections within 700.

FIG. 20 illustrates expanded detail of FIG. 18, 1801 Build Neurons process, showing the subprocesses necessary to allocate neurons and the neurons' dendrite and axon allocation processes. 1801 begins with 2001 Iterate Through Columns process which takes as its input 1632 Distribution Tables Level 3 (as detailed in Table 10). Every layer in Table 10 is iterated through as well as all the layer's rows and columns. The layer parameters from Table 10 have the numbering convention 16321, 16322, etc. The row parameters within a layer have a numbering convention of 1632110, 1632120, etc. The column parameters within a row have a numbering convention of 1632111, 1632112, etc. When a particular layer, row and column are identified then the column number (Table 10 parameters with the numbering convention 1632111A, 1632112A, etc.) is used as an index into 1405 Column Definition Tables (Table 11) for entries with parameters 140501, 140502, etc. Then for each column number, 2002 Iterate Through Layers per Column iterates through all the next level of Table 11: layers within a column definition. This next level has parameters designated by the convention 1405011, 1405012, 1405013, etc. Next, 2003 Iterate Through Neurons per Layer, iterates through all of the neurons to be allocated for this particular column at this particular layer. The numbering convention for these parameters in Table 11, for column 1 and layer 1 as an example, are 140501101, 140501102, 1405011103, etc. for the first three neurons. Next, 2004 Calculate Column Coordinates, currently holding the neuron type for this column at this layer as passed from 2003, retrieves the coordinates for this column (Table 10 parameters 1632111C, 1632112C, etc.) and calculates coordinates for this neuron allocation. Coordinates are assigned according to the column's coordinates including the z-axis for neurons in cortex layer 1. However, a slight random deviation is applied within the bounds of the column's diameter of 0.059 mm² for the x and y-axis coordinates so that all neurons within a column do not receive the same coordinates. Coordinates for additional layers within the same column receive an additional 0.5 mm for the z-axis coordinate per layer; as well as receiving the random deviation for x and y-axis coordinates described above for layer 1. 2005 Allocate Neuron is the process called next and, in the vernacular of object oriented programming, physically instantiates an object of type Neuron. The instantiation calls the object's constructor which fills out the following parameters for 400 Neurons as detailed in Table 19 Neurons.

TABLE 19
Neurons

| Parameter | Description |
|---|---|
| 4001 neuronID | Neuron ID |
| 400101 neuronType | Neuron type |
| 400102 neuronCoordinates | Neuron coordinates |
| 400103 neuronColumnID | Neuron's column id |

| | |
|---|---|
| 400104101 neuronApicalDendLayer1-01 | Neuron apical dendrite layer 1 # 1 |
| 400104102 neuronADNMDAValue | Neuron apical dendrite NMDA value |
| 400104103 neuronADGABAValue | Neuron apical dendrite GABA value |
| 400104104 neuronADAcetylcholineValue | Neuron apical dendrite acetylcholine value |
| 400104105 neuronADDopamineValue | Neuron apical dendrite dopamine value |
| 400104106 neuronADVoltageValue | Neuron apical dendrite voltage value |
| 400104107 neuronADCurrentValue | Neuron apical dendrite current value |
| 400104108 neuronADSpikeAccumulate | Neuron apical dendrite spike accumulation |

| | |
|---|---|
| 400104109A neuronBDSTDPShort | Neuron basal dendrite short term STDP |
| 400104109B neuronBDSTDPLong | Neuron basal dendrite long term STDP |
| 400104109C neuronBDFromExcitatory | Neuron basal dendrite excitatory - yes/no |
| 400104109D neuronBDSomaID | Neuron basal dendrite from soma ID |
| 400104109E neuronBDAxonLevel | Neuron basal dendrite from axon level |
| 400104109F neuronBDTag | Neuron basal dendrite tag value |
| 400104109G neuronBDBuildOut | Neuron basal dendrite build out value |

| | |
|---|---|
| 400104201 neuronApicalDendLayer2-01 | Neuron apical dendrites layer 2 # 1 |

| | |
|---|---|
| • | • |

| | |
|---|---|
| 40010501 neuronAxonElement1 | Neuron axon element 1 |
| 40010502 neuronAxonElement2 | Neuron axon element 2 |

| | |
|---|---|
| • | • |

| | |
|---|---|
| 40010601 neuronVoltage | Neuron's voltage value |
| 40010602 neuronCurrent | Neuron's current value |
| 40010603 neuronCapillary | Neuron's capillary value |
| 40010604 neuronSTDPdecay | Neuron's STDP short term decay |
| 40010605 neuronSpikeAccumulate | Neuron's spike accumulation |
| 40010606 neuronParameter 1 | Neuron's parameter 1 value |
| 40010607 neuronParameter 2 | Neuron's parameter 2 value |
| 40010608 neuronParameter 3 | Neuron's parameter 3 value |

| | |
|---|---|
| • | • |

| | |
|---|---|
| 4002 neuronID | Neuron ID |

| | |
|---|---|
| • | • |

First, Table 19 4001 neuron id is added. This is a unique number for every neuron; begins at 1 and is incremented for each neuron processed. The ID comes from parameter 120707 from 1207 (Table 7), passed via 2004, and is incremented for the next allocation and written back to 1207. Next, Table 19 400101 neuron type is filled in. That data comes from Table 11's parameters passed from 2003 with numbering conventions 140501101, 140501102, etc. Finally, parameter 400103 is filled in by copying 1632111B (for example and copied from processes in 2004) to establish what specific column id this neuron resides in. At this point the new neuron exists and the constructor passes further processing to 2006 Initialize Neuron. First of all, 2006 fills in Table 19's 400102 coordinates parameter from the calculation performed by 2004 and described above. Then there is a copy performed from Table 12 to Table 19. This is for neuron specific parameter values that can vary according to the neuron type and more importantly will vary according to the user's neuron definition. The tool is flexible and can accommodate virtually any type of neuron model from a simple Integrate and Fire to the complex Hodgkin Huxley. The neuron type in Table 19 (400101 for example) is matched into Table 12's parameters numbered 140201, for example, and the parameters residing there (14020101 to 14020106 for example) are copied into Table 19's parameters numbered 40010601 to 40010606 for example. Next, 2007 Allocate Apical Dendrites is called to allocate an apical dendrite per layer where the user has designed basal dendrites to reside. This process utilizes Table 11 for this column, this layer, this neuron type as passed from the aforementioned processes: 2001 through 2006. Within Table 11 are parameters where apical dendrites are to reside at particular layers. Which layers the apical dendrites reside is a user design decision but must minimally include the layer in which the neuron soma is allocated. These parameters are numbered like 140501101B1 for the first neuron allocated in column 1, layer 1 and with an apical dendrite in layer 1. Whenever an entry for an apical dendrite exists for a neuron in Table 11 that information causes an entry to be added to Table 19's parameters numbered 400104101, 400104201, etc. Finally, 2008 Allocate Axon is called to allocate an axon structure for this neuron. Axons must be created per neuron to satisfy the user's design, which for any given neuron might only require a neuron to communicate locally within a column or to communicate globally to a different column in a remote location. Also, this tool supports multiple signals on a single axon. Thus an axon is implemented as an array structure in which any given element can be carrying information towards its destination. To allocate the axon a search is done through 1502 Intercolumns Connections Tables (Table 14) when the table exists at all, i.e. if the user included it in their design. If the table exists then it is checked first to see if the current column and neuron are to be connected somewhere in Table 14. To accomplish this search the three distribution tables (Tables 8-10) are searched top down. Table 8 parameter 1612111A (for example) points to Table 9 1622111 (for example) and 1622111A points to Table 10 parameter 1632111 (for example) and 1632111B points to Table 11 140501 (for example). Then the 140501101 parameter from Table 11 which points to a neuron type is extracted. When all four parameters 1622111A, 1622111A, 1632111B and 140501101 match Table 14's parameters 150201A, 150201B, 150201C and 150201D then that indicates a from match for “from” neuron 140501101 and now its axon length, determined by 140501101's coordinates 400102 from Table 19, can be determined from the maximum distance to the neurons which follow in Table 14 150202D (for example). At this juncture, the concern is the maximum length of the axon array to be allocated and not the multiple possible connections between an axon and multiple receiving dendrites. The latter issue is covered beginning with FIG. 21. In order to determine the coordinates of the “to” neuron's apical dendrite the top-down search through the distribution tables is revisited but this time according to a match between the distribution tables and the parameters from Table 14's parameters numbered 15020101A, 15020101B, 15020101C and 15020101D (for example). All of the latter parameters are searched for the maximum of their neurons' coordinates and that distance determines the length of the axon and the number of elements for parameter 40010501, 40010502, etc. to be allocated for Table 19.

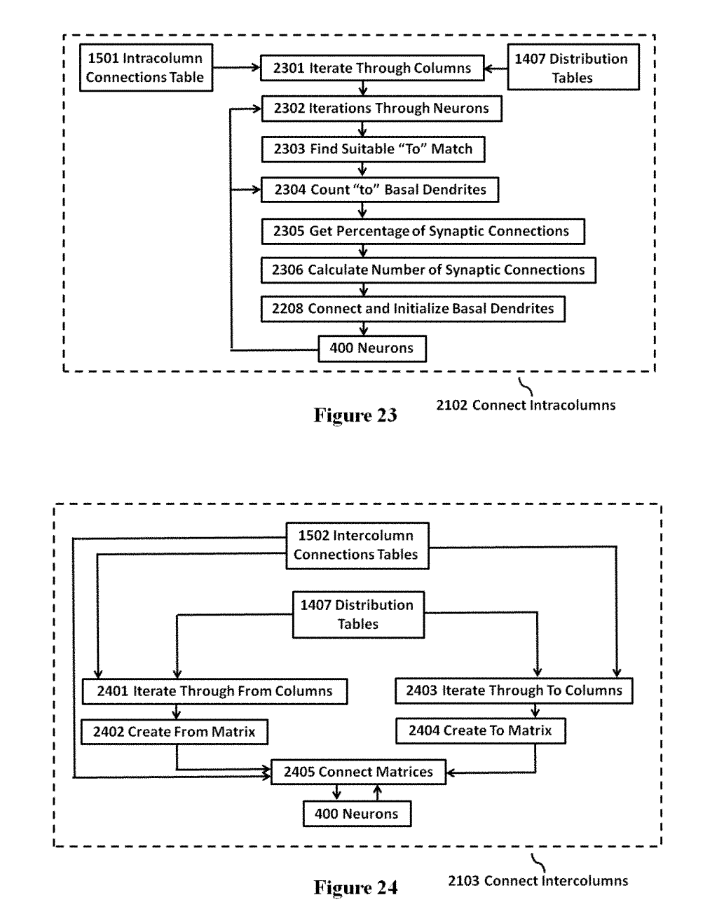

FIG. 21 illustrates expanded detail of FIG. 18's 1802 Connect Neurons process. In FIG. 21 three connect processes are shown: 2101 Connect Within Columns (detailed in FIG. 22), 2102 Connect Intracolumns (detailed in FIG. 23) and 2103 Connect Intercolumns (detailed in FIG. 24). All three connect processes, 2101, 2102 and 2103, receive input from 1632 Distribution Tables Level 3 and 400 Neurons. Additionally, 2102 receives input from 1501 Intracolumn Definition Tables and 2103 receives input from 1502 Intercolumn Definition Tables. 2101 supports all the neuronal connections made within a specific column. 2102 supports connections made between neighboring columns and 2103 supports short and long distance connections. A short distance is exemplified by connections made within a cortical area e.g. Area 17 depicted in FIG. 2 and long distance is exemplified by connections between different areas or structures, e.g. 110 Diencephalon and 111 Thalamus depicted in FIG. 1.

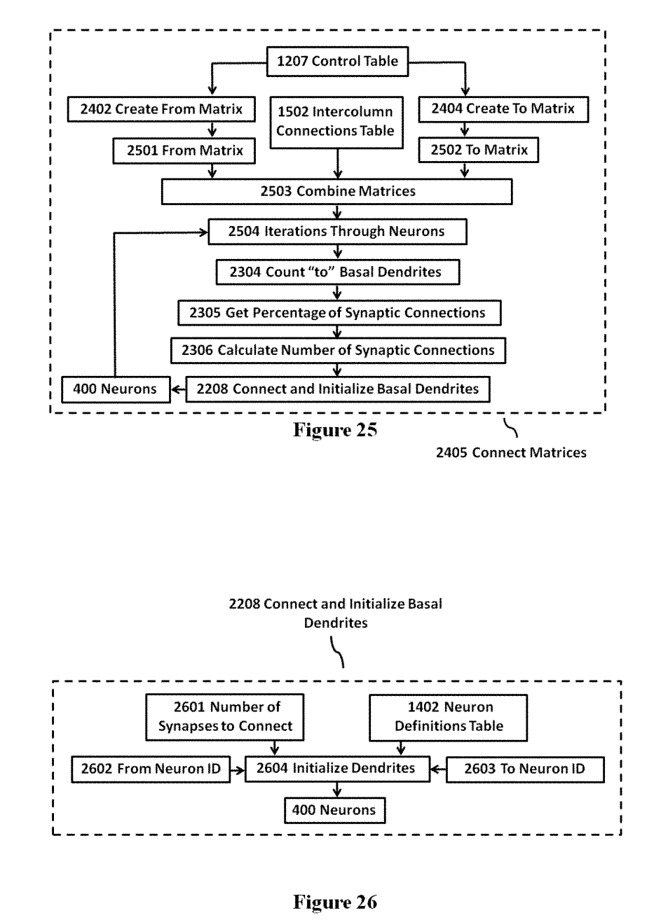

FIG. 22, 2101 Connect Within Columns, illustrates expanded detail of FIG. 21's 2101 Connect Within Columns process. 2101 begins with 2001 Iterate Through Columns process which takes as its input 1632 Distribution Tables Level 3 (as detailed in Table 10). Every layer in Table 10 is iterated through as well as all the layer's rows and columns. The layer parameters from Table 10 have the numbering convention 16321, 16322, etc. The row parameters within a layer have a numbering convention of 1632110, 1632120, etc. The column parameters within a row have a numbering convention of 1632111, 1632112, etc. When a particular layer, row and column are identified then the column number (Table 10 parameters with the numbering convention 1632111A, 1632112A, etc.) is used as an index into 1405 Column Definition Tables (Table 11) for entries with parameters 140501, 140502, etc. Then for each column number, 2002 Iterate Through Layers per Column iterates through all the next level of Table 11: layers within a column definition. This next level has parameters designated by the convention 1405011, 1405012, 1405013, etc. Next, 2203 Iterate Through Neurons per Layer, uses 140501101, 140501102, etc. to iterate through neuron types at a particular layer for a particular column. For every neuron type, 400 Neurons is searched for a matching column id, parameter 400103 and matching neuron type, parameter 400101, to match the current 1632111B from Table 10 and current 140501101 from Table 11. With this match for a specific column and its layer and its neurons, which represent the “to” neurons in 1405, then process 2204 Iterate Through Apical Dendrites per Neuron iterates through the apical dendrites for this particular neuron and uses 400104101, 400104201, etc. to accomplish this. Then the “from” neurons in Table 11 are iterated through as is represented by 2205 Iterate Through From Neurons. 2205 iterates through parameters numbered 140501101D101A, 140501101D102A, which contain the “from” neuron type. For each entry, 2206 Get Percentage of Synaptic Connections gets the adjacent parameter 140501101D101B (for example), which contains the percentage of basal dendrites that the “from” neuron should connect to the “to” neuron. Then, 2207 Calculate Number of Synaptic Connections, uses the percentage 140501101D101B and multiplies it by the parameter 140501101C1, which is the total number of basal dendrites for this particular neuron. The result of the calculation is the number of synapses to connect and this number is passed to 2208 Connect and Initialize Basal Dendrites, which is further detailed in FIG. 25. The connected basal dendrites as well as the apical dendrites are initialized and written to 400 Neurons' parameters 400104101 through 400104108D (for example).

FIG. 23, 2102 Connect Intracolumns, illustrates expanded detail of FIG. 21's 2102 Connect Intracolumns process. 2102 begins with 2301 Iterate Through Columns process which takes as its input 1407 Distribution Tables (as detailed in Tables 8, 9 and 10). The concept here is that the connections to be made are between multiple adjacent columns, which implies access to multiple columns simultaneously (unlike 2101 Connections Within Columns which only looks at a single column at a time). This permits that adjacent columns will have different column IDs and that implies a requirement to iterate through the distribution tables. Thus, 2301 begins with Table 8 and iterates through all parameters numbered as 1612111A, 1612112A, etc. These are pointers to cells in Table 9 and these cells within Table 9 are iterated through to establish parameters 1622111A, 1622112A, etc. which in turn are pointers to Table 10 parameters 1632111A, 1632112A, etc. For each unique combination of 1612111A, 1622111A and 1632111A (for example) the combination is compared to the entries in 1501 Intracolumn Connections Table (Table 13) for “from” parameters numbered 150101A, 150101B and 150101C. When a match for all 6 parameters is established then the “from” neuron type and the “to” neuron types, 150101D and 150101E (respectively for example) are extracted as well as the unique “from” column ID (1632111B for example) and the 150101F parameter which indicates the percentage of total “to” basal dendrites to connect. Next, 2302 Iterations Through Neurons, makes its first pass through 400 Neurons looking for 400101 (for example) to match 150101D (for example). When a match occurs the 163211B column ID is compared to the 400103 column ID. If a match isn't found the iterations through 400 continue. Else, the 400102 neuron coordinates are captured and then 400 is iterated again to find a match with “to” neuron parameters 150101E and 400101. When a match is found then the column ID parameters 163211B and 400103 (for example) are compared. If they are the same then the second iteration continues. Else, two different columns (the prerequisite of 2102) with the right combination of “from” and “to” neurons have been established. The final comparison which must then be made is between the “from” and “to” neurons' coordinates. Only neurons that are within a one-half column diameter qualify for intracolumn connections. So to establish this, the two neurons' 400102 neuron coordinates are used to compute the three dimensional distance between them using the formula:\sqrt{(₂−₁)²+(₂−₁)²+(₂−₁)²}≤120722(7)/2. Here the coordinates of the “from” neuron have a subindex of “2” and that of the “to” neuron have a subindex of “1” and (coordinates are 400102 for example) the column's diameter is represented as 120722. When all of these conditions are met then a suitable match has been found. Next, 2304 Count “to” Basal Dendrites counts the basal dendrites allocated to the “to” neuron. To do this 2304 goes to the 400104101 parameter (for example) at the layer for the “to” neuron's allocation (known by the neuron's type number 400101) and the basal dendrites are counted one by one. Next, 2305 Get Percentage of Synaptic Connections gets parameter 150101F and passes that to 2306 Calculate Number of Synaptic Connections. 2306 uses 150101F and multiplies it times the number of basal dendrites calculated in 2304. The resultant calculation is passed to 2208, which connects the “from” neuron's axon to the “to” neuron's basal dendrites as well as initializing the basal dendrites, which is further detailed in FIG. 26.

FIG. 24 illustrates expanded detail of FIG. 21's 2103 Connect Intercolumns process. 2103 begins with 2401 Iterate Through From Columns process which takes as one of its inputs 1407 Distribution Tables (as detailed in Tables 8, 9 and 10). The concept here is that the connections to be made are between multiple columns, which implies that we must have access to multiple columns on both the sending and receiving side (unlike 2101 Connections Within Columns which only looks at a single column at a time). Thus, 2401 begins with Table 8 and iterates through all parameters numbered as 1612111A, 1612112A, etc. These are pointers to cells in Table 9 and these cells within Table 9 are iterated through to establish parameters 1622111A, 1622112A, etc. which in turn are pointers to Table 10 parameters 1632111A, 1632112A, etc. For each unique combination of 1612111A, 1622111A and 1632111A (for example) the combination is compared to the entries in 1502 Intercolumn Connections Table (Table 13) for “from” parameters numbered 150201A, 150201B and 150201C. When a match for all 6 parameters is established the column id (1632111B) and column coordinates (1632111C), as examples, are stored in a temporary list. When the iterations are completed the list is passed to 2402 Create From Matrix. 2402 sorts the “from” list by column coordinates into a two dimensional matrix of column ids. Then 2403 Iterate Through To Columns process takes as one of its inputs 1407 Distribution Tables (as detailed in Tables 8, 9 and 10). 2403 begins with Table 8 and iterates through all parameters numbered as 1612111A, 1612112A, etc. These are pointers to cells in Table 9 and these cells within Table 9 are iterated through to establish parameters 1622111A, 1622112A, etc. which in turn are pointers to Table 10 parameters 1632111A, 1632112A, etc. For each unique combination of 1612111A, 1622111A and 1632111A (for example) the combination is compared to the entries in 1502 Intercolumn Connections Table (Table 13) for “to” parameters numbered 15020101A and 15020101B (for example). When a match for all 6 parameters is established the column id (1632111B) and column coordinates (1632111C), as examples, are stored in a temporary list. When the iterations are completed the list is passed to 2404 Create To Matrix. 2402 sorts the “to” list by column coordinates into a two dimensional matrix of column ids. The two matrices from 2402 and 2404 are then passed to 2405 Connect Matrices (detailed in FIG. 25), which connects the neurons in the two matrices and updates the basal dendrites parameter per “to” neuron in particular (400104108D for example).

FIG. 25, 2405 Connect Matrices, illustrates expanded detail of 2405 from FIG. 24. 2405 begins with 2402 Create From Matrix, mentioned in FIG. 24. As detailed in FIG. 24, 2402 is in possession of a list of column ids (1632111B for example) and their coordinates (1632111C for example). 2402 searches the coordinates looking for the minimum x coordinates and minimum y coordinates. Those coordinates are assigned temporary minimum x, y values for what will be the “from” matrix. Next, the maximum x and y coordinates are searched for and those coordinates are assigned temporary maximum x coordinates and maximum y coordinates. The difference between maximum and minimum y coordinates are divided by the width of a single column, parameter 120722 in Table 7, which yields the number of y elements of the “from” matrix. Similarly, The difference between maximum and minimum x coordinates are divided by the depth between single layers, parameter 120723 in Table 7, which yields the number of x elements of the “from” matrix. The number of x and y elements are then used to allocate the “from” matrix. Then, the list of column ids are assigned to “from” matrix elements accordingly. Next, 2404 Create To Matrix, uses a similar set of operations to create the “to” matrix, 2502 To Matrix. 2404 searches the coordinates looking for the minimum x coordinates and minimum y coordinates. Those coordinates are assigned temporary minimum x, y values for what will be the “from” matrix. Next, the maximum x and y coordinates are searched for and those coordinates are assigned temporary maximum x coordinates and maximum y coordinates. The difference between maximum and minimum y coordinates are divided by the width of a single column, parameter 120722 in Table 7, which yields the number of y elements of the “to” matrix. Similarly, The difference between maximum and minimum x coordinates are divided by the depth between single layers, parameter 120723 in Table 7, which yields the number of x elements of the “to” matrix. The number of x and y elements are then used to allocate the “to” matrix. Then, the list of column ids are assigned to “to” matrix elements accordingly. Next, 2503 Combine Matrices is called to link up “from” to “to” columns so that neurons may be connected accordingly. To accomplish this 2503 must access several parameters from 1502 Intercolumn Connections Table (Table 14). The first parameter is 150201E (for example), which allows for the “from” matrix to be interpreted as having its beginning element on any corner of the matrix. As an example, the bottom-right-most element in the “from” matrix can be connected to the top left-most element of the “to” matrix by specifying “br” for bottom right. If the user doesn't care about such direct connection relationships they can also specify “r” for random, which causes the entire “from” matrix to be randomized. The second parameter is 150201F which specifies the receiving density: equal, sparse or dense. “Density” refers to how the “from” columns are to be parceled amongst the “to” columns. If “equal” then there is one-to-one correspondence between “from” and “to” columns. On the other hand, if “sparse” then there is a one-to-many connection policy and the ratio of the number of “from” columns compared to “to” columns determines how many “to” columns should be connected from a single “from” column. If 150201F is specified as “dense” then the ratio of “from” to “to” columns determines how many “from” columns should connect to the same “to” column. Altogether, 150201E and 150201F give the user immense yet automated control of group connections without having to worry about individual column connection specifications. This is an especially important consideration when the number of columns numbers in the thousands, tens of thousands or greater at which point a column by column user defined connection scheme would be virtually impossible to accomplish in a timely fashion. 2503's next action after retrieving the two parameters is to count the number of columns in the “from” and “to” matrices. Next, if 150201E is “r” then the “from” matrix is randomized by going through the entire matrix, element by element” and swapping that element with a random element elsewhere in the matrix. Next, if not random, then the “from” indices are established according to “top/bottom” and “left/right”, i.e. where the iteration from the “from” matrix begins. Next, the density is checked and the “from” and “to” column numbers counted. The result is to control the iterations from the “from” matrix columns to the “to” matrix columns before incrementing the “from” indices. 2503 starts the iterations and controls how the iterations are performed and for each iteration the “from” and “to” neuron types (150201D and 15020101D for example) are passed to 2504 Iterations Through Neurons. The first iteration is to locate a “from” neuron using the neuron type parameter 150201D from Table 14 to match with Table 19 400101 neuron type and to match Table 19's 400103 column id (for this particular neuron) with the id for the column id passed via the “from” matrix element. There will likely be multiple “from” neurons so these iterations for “from” neurons continues until the end of Table 19. With a particular “from” neuron identified then an additional 2504 iteration takes place looking for a “to” neuron which matches Table 14's 15020202D “to” neuron type with Table 19 400101 neuron type and to match Table 19's 400103 column id (for this particular neuron) with the id for the column id passed via the “to” matrix element. With specific “from” and “to” neurons identified, the pair are passed to 2304 Count “to” Basal Dendrites. 2304 counts the basal dendrites allocated to the “to” neuron. To do this 2304 goes to the 400104101 parameter (for example) at the layer for the “to” neuron's allocation (known by the neuron's type number 400101) and the basal dendrites are counted one by one. Next, 2305 Get Percentage of Synaptic Connections gets parameter 150101F and passes that to 2306 Calculate Number of Synaptic Connections. 2306 uses 150101F and multiplies it times the number of basal dendrites calculated in 2304. The resultant calculation is passed to 2208, which connects the “from” neuron's axon to the “to” neuron's basal dendrites as well as initializing the basal dendrites, which is further detailed in FIG. 26.

FIG. 26 illustrates expanded detail of 2208 Connect and Initialize Basal Dendrites referred to by the connect and initialize processes from FIGS. 22, 23, 25, 29 and 30. 2208 begins with 2604 Initialize Dendrites, which takes as one of its inputs 2601 Number of Synapses to Connect, which might have resulted from either of 2207 Calculate Number of Synaptic Connections or 2306 Calculate Number of Synaptic Connections. 2601 represents the number synapses to connect between a sending neuron's axon and the receiving neuron's basal dendrites at a particular layer, i.e. for a particular apical dendrite. 2604 also receives input from 1402 Neuron Definitions Table (Table 12), which contains the constants which will fill in most of the neuron's basal dendrite parameters. Finally, 2604 takes inputs of the “from” and “to” neuron ids from 2602 From Neuron ID and 2603 To Neuron ID respectively. Now, the “to” dendrite parameters, which includes both apical dendrite and basal dendrites, can be filled in. Apical dendrites and the associated basal dendrite parameters in Table 19 are numbered 400104101 to 400104108E as an example. These parameter values are copied One for One from the Neuron Definitions Table (Table 12 parameters 14020107A to 14020108C for example) and are the same for any basal dendrite at any layer for any neuron, with two exceptions. The first exception is that 400104108C is 1 or 0 depending on whether or not the sending axon stems from an excitatory or inhibitory neuron. To establish this, 2604 looks at the 40010608 parameter of the “from” neuron, which was initialized to 1 or 0 at the time the “from” neuron was constructed. The second exception is that 400104108D and 400104108E are based upon the “from” neuron's id and axon level (4001 and 40010501 respectively for example). The axon level is based on the distance from the “from” neuron's soma level coordinates (where the axon begins) and the apical dendrite coordinates of the “to” neuron (all of the basal dendrites assume the coordinates of the apical dendrite). The axon level is calculated from the three dimensional distance between the two sets of coordinates using the formula: \sqrt{(₂−₁)²+(₂−₁)²+(₂−₁)²}/pa coordinates with a “2” subscript are the receiving apical dendrite coordinates and the “1” subscript is the sending soma's coordinates. Coordinates for the “1” subscript come from Table 19's 400102 for example and for “2” subscript also use 400102 but with the z coordinate adjusted by 0.5 mm per layer of the apical dendrite's distance from the soma. Parameter is the axon's conduction velocity which comes from Table 7 parameter 120724 or 120725 depending on whether the axon is myelinated or not. The parameter values are set by the user and can be expanded to account for conduction velocity based upon axon diameters amongst other considerations. Note that parameters 14020107A to 14020107E are very specific to the user's neuron model. The tool accommodates dendrites with multiple different receptor types e.g. NMDA and dopamine, however the user can change these as their model requires.

FIG. 27 illustrates expanded detail of FIG. 19's 1901 Build Astrocytes process. 1901 begins with 2701 Get 3 Closest Neuron Neighbors which iterates through 400 Neurons looking through all neurons to ascertain which three neurons are closest to the current neuron based upon a three dimensional distance equation \sqrt{(₂−₁)²+(₂−₁)²+(₂−₁)²}≤120722(7). Here the coordinates of the “from” neuron have a subindex of “2” and that of the “to” neuron have a subindex of “1” and (coordinates are 400102 for example) and parameter 120722 a single column's diameter. The three closest are searched for but it is quite possible that there may be less than 3 if there are less than 3 neurons within one column's distance. When up to the three closest neurons are found then they are passed to 2702 Verify Neurons Have No Astrocyte to check if the three are already “spoken for” by virtue of having already been associated with some other astrocyte. If so, 2701 continues its check for other neighbor candidates. When up to three neurons are verified (or less if the entire 400 Neurons has been searched) by 2701 and 2702 then up to four neurons are passed to 2703 Allocate Astrocyte, which physically allocates the astrocyte object and copies the neuron ids which the astrocyte surrounds to parameter 700102. 2703 also calculates coordinates for the astrocyte soma based upon the midpoint of up to four neurons' coordinates. The midpoint is established by taking the maximum distance plus the minimum distance and dividing by 2. The calculation works for 2 to 4 neurons. The purpose of the astrocyte in this tool is to monitor (up to) the four surrounded neurons for synaptic activity and adjust blood flow accordingly (the more activity the more blood flow and conversely). Blood flow to the neurons is adjusted by the astrocyte endfeet, attached to centrioles (smallest of blood vessels), which open up or tightens down the centriole's diameters that in turn supply resources to the neurons' basal dendrites. The astrocyte object is then written out to 700 Astrocytes and control passes to 2704 Initialize Astrocyte. The remaining astrocyte parameters to be initialized are copied from 1207 (Table 7) which includes 120709 astrocyte id. For every astrocyte allocated 120709 is incremented by 1 and written back to 120709.

FIG. 28 illustrates expanded detail of FIG. 19's 1902 Connect Astrocytes process. 1902 begins with 2801 Get 3 Closest Astrocyte Neighbors which picks an astrocyte one at a time then iterates through the rest of 700 Astrocytes looking for up to three astrocytes which are closest to the current astrocyte based upon a three dimensional distance equation \sqrt{(₂−₁)²+(₂−₁)²+(₂−₁)²}≤2*120722(7). Here the coordinates of the “from” astrocyte have a subindex of “2” and that of the “to” astrocyte have a subindex of “1” and (coordinates are 400102 for example) and parameter 120722 a single column's diameter. The three closest are searched for but it is quite possible that there may be less than 3 if there are less than 3 astrocytes within two columns' distance. When up to the three closest astrocytes are found then they are passed to 2802 Verify Astrocytes are Available to check if the three are already “spoken for” by virtue of each one having already been associated with three other astrocytes. If so, 2802 continues its check for other neighbor candidates. When up to three astrocytes are verified (or less if the entire 700 Astrocytes has been searched) by 2801 and 2802 then up to three astrocyte ids are copied to 700 parameter 700103 (Table 20).

TABLE 20
Astrocytes

| Parameter | Description |
|---|---|
| 7001 astrocyteID | astrocyte ID |
| 700101 astrocyteCoordinates | astrocyte coordinates |
| 700102 astrocyteNeurons | astrocyte's neurons surrounded |
| 700103 astrocyteNeighbors | astrocyte's neighbors connected |
| | to |
| 700104 astrocyteSomaValue | astrocyte's soma value |
| 700105 astrocyteArterioleSize | astrocyte's arteriole size |
| 700106 astrocyteNeighborsSomaValue | astrocyte's neighbors' soma |
| | values |
| 700107 astrocyteRelease | astrocyte's release event value |
| 7002 astrocyteID | astrocyte ID |

| | |
|---|---|
| • | • |

FIG. 29 illustrates expanded detail of FIG. 17's 1408 System Builds Buffers process. FIG. 29 is for input buffers for peripheral nervous system modalities, e.g. vision and hearing. Additionally, FIG. 29. is for cortical nuclei that are reactive to blood circulating hormones, peptides, etc. FIG. 30 is for output buffers. Each of the aforementioned input modalities require that the user creates code to interface the non-neuronal components so that the transduced data becomes a neural signal and so must have an input buffer accordingly. Hence, within the user's code for each modality the following steps must be followed. First, FIG. 29 begins with 2901 Iterate Through Neurons process, which takes as its input 400 Neurons. 2901 looks at each neuron and extracts its type (400 parameter 400101) and passes it to 2902 Compare Neuron Type to Peripheral Type, which takes additional inputs of 1407 Distribution Tables (Tables 8, 9 and 10) and 1207 Control Table (Table 7). 2902 reads each of the sets of Peripheral Nervous System (PNS) entries in Table 7 numbered 120727, 120728 and 120729 (for example) and then iterates through 1407 looking to match 1612111A in Table 8, 1622111A in Table 9 and 1632111A in Table 10 (for example). When a match is found then 2902 looks to match neuron types 400101 with 120730 in Table 7 (for example) and match the column ids 1632111B in Table 10 and 400103 in Table 19 (for example). When column ids and neuron types match then 2903 compares 120730 in Table 7 with “1” that indicates input type. If input type then 2904 Increment Input Buffer Size increments the intended input buffer size (one input buffer element per receiving neuron) and 2905 Track Neuron IDs extracts 4001 neuron id. When all neurons for all PNS entries have been completed then 2906 Allocate Buffer allocates an input buffer (1503 Input Buffer) the size of the number of input neurons. Then the following parameters are copied to the resultant buffer in 1503 (Table 15): 150301A receives the PNS name from 120726, 150301B is initialized to 0, 150301C receives the 4001 neuron id for this buffer element (the particular element numbers are examples which depend on the particular entry). Next, 2208 Initialize Basal Dendrites initializes the basal dendrites for each of the 400 Neurons contained in the 1503 Input Buffer as detailed in FIG. 26.

FIG. 30 illustrates expanded detail of FIG. 17's 1408 System Builds Buffers process. FIG. 30 is for output buffers for peripheral nervous system modalities, e.g. musculature. Additionally, FIG. 30. is for cortical nuclei that generate blood circulating hormones, peptides, etc. Each of the aforementioned output modalities require that the user creates code to interface the non-neuronal components so that a neural signal becomes transduced data and so must have an output buffer to hold the neural data before transduction. Hence, within the user's code for each modality the following steps must be followed. First, FIG. 30 begins with 2901 Iterate Through Neurons process, which takes as its input 400 Neurons. 2901 looks at each neuron and extracts its type (400 parameter 400101) and passes it to 2902 Compare Neuron Type to Peripheral Type, which takes additional inputs of 1407 Distribution Tables (Tables 8, 9 and 10) and 1207 Control Table (Table 7). 2902 reads each of the sets of Peripheral Nervous System (PNS) entries in Table 7 numbered 120727, 120728 and 120729 (for example) and then iterates through 1407 looking to match 1612111A in Table 8, 1622111A in Table 9 and 1632111A in Table 10 (for example). When a match is found then 2902 looks to match neuron types 400101 with 120730 in Table 7 (for example) and match the column ids 1632111B in Table 10 and 400103 in Table 19 (for example). When column ids and neuron types match then 3001 compares 120730 in Table 7 with “0” that indicates output type. If output type then 3002 Increment Output Buffer Size increments the intended output buffer size (one output buffer element per sending neuron) and 2905 Track Neuron IDs extracts 4001 neuron id. When all neurons for all PNS entries have been completed then 3003 Allocate Buffer allocates an output buffer (1504 Output Buffer) the size of the number of output neurons. Then the following parameters are copied to the resultant buffer in 1504 (Table 16): 150401A receives the PNS name from 120726, 150401B is initialized to 0, 150401C receives the 4001 neuron id for this buffer element (the particular element numbers are examples which depend on the particular entry). Next, 2208 Initialize Basal Dendrites initializes the basal dendrites for each of the 400 Neurons contained in the 1504 Output Buffer as detailed in FIG. 26.

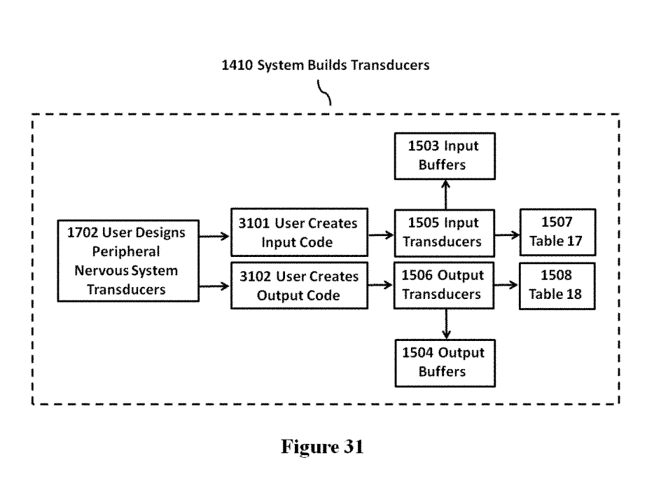

FIG. 31 illustrates expanded detail of FIG. 17's 1410 System Builds Transducers for both input and output transducers. 1410 begins with 1702 User Designs Peripheral Nervous System Transducers. For every PNS modality as well as nuclei that create or react to hormones, peptides, etc. 1702 must account for code which will translate/transcribe input data in non-neural form (analog) into a neural (digital) form and which will translate/transcribe output data from a neural form to a non-neural form. For the input case the user must account for how many neurons could be potential activated by the data as well as how many neurons should receive redundant data. The user must also account for the spectrum of the data and how finely that spectrum should be accounted for. As well, the user needs to pay attention as to how a brain actually achieves the same results. From this knowledge the user can simplify the biology if they so choose. This is particularly relevant to sensory systems like vision which work on a completely different premise than cameras which serve as the most convenient form of visual input. On the other hand, blood products are straight forward and the major design decisions are about sensitivity to the molar density of the circulating blood product, the rate at which the product degenerates and the volume rate at which the product can be produced. The input design decisions lead to 3101 User Creates Input Code (preferably written in Java but any language can be interfaced) and 3101 produces the individual 1505 Input Transducers (code) which feed 1503 Input Buffers. Part of the 1505 process requires the user to copy the name of their code's module to 1507 Table 17 parameter 150501 (for example). During runtime updates, the system refers to Table 17 for the names of modules to be called. For the output case the user must account for how many neurons will activate the external activators (for example) as well as how many neurons might be transmitting redundant data. The user must also account for the spectrum of the data and how finely that spectrum should be accounted for. As well, the user needs to pay attention as to how a brain actually achieves the same results. From this knowledge the user can simplify the biology if they so choose. This is particularly relevant to systems like musculature which utilize thousands to millions of neurons in order to move a complex system like fingers, hands and arms in a coordinated fashion. On the other hand, production of blood products are straight forward and the major design decisions are about the creation of molar density of the circulating blood product, the rate at which the product degenerates and the volume rate at which the product should be produced. The output design decisions lead to 3102 User Creates Output Code (preferably written in Java but any language can be interfaced) and 3102 produces the individual 1506 Output Transducers (code) which feed 1504 Output Buffers. Part of the 1506 process requires the user to copy the name of their code's module to 1508 Table 18 parameter 150601 (for example). During runtime updates, the system refers to Table 18 for the names of modules to be called.

TABLE 18
Output Transducer Information

| Parameter | Description |
|---|---|
| 150601 transducerName1 | Name of transducer for output buffer 1 |
| 150602 transducerName2 | Name of transducer for output buffer 2 |

| | |
|---|---|
| • | • |
| • | • |
| • | • |

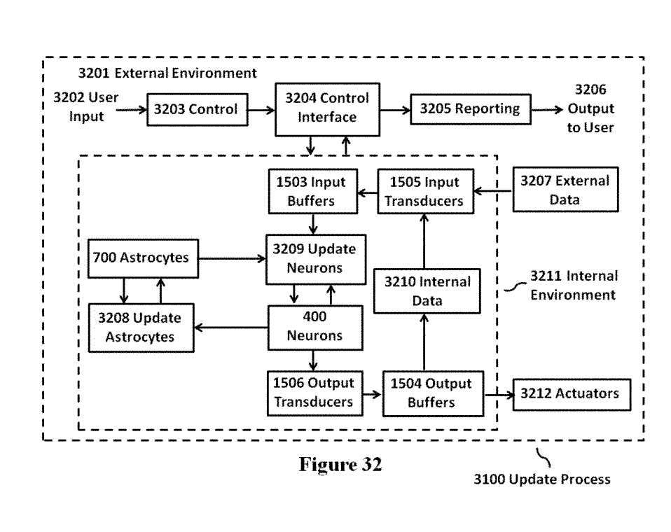

FIG. 32 illustrates an overview of the 3100 Update Process. First of all, 3100 involves environments external to the emulated nervous system, 3201 External Environment, as well as the internal environment of the emulated nervous system, 3211 Internal Environment. 3201 begins with the user initiating a “run” which comes from 3202 User Input. 3202 has the capability of initiating a simulation “run” as well as controling the information to be displayed or accumulated during the run. All of the users commands are read and interpreted by 3203 Control, which directs the user's commands to either a reporting command, sub-interpreted by 3205 Reporting (which produces output to the user's console or report file or both via 3206 Output to User), or by a command to initialize and start the runtime process, which causes 3211 to begin. 3211 begins with 3207 External Data which brings data from the “external” environment. This could be data external to the system, like vision, or could be simulated data produced by 1506 Output Transducers for things like circulating blood components. In order to simulate the massive parallelism of a biological system, 3100 works in two passes for each update cycle. The first is to bring all updates from external or internal data to basal dendrites of each neuron and the second pass processes the new data at a soma level for every neuron, which potentially produces axonal output for the input phase of the next cycle. This achieves a biological realism without the possible encumbrance of simulation race conditions, which can occur at a local level if a neuron were allowed to read/write data without regard to any synchronization. Both 3207 External Data (e.g. vision) and 3210 Internal Data (e.g. hormones) are processed by 1505 Input Transducers, which translates the non-neural signals into neural signals. 1505 places the translated data into 1503 Input Buffers. Next, 3209 Update Neurons, processes 1503 data as well as axon signals brought out from 400 Neurons in a first pass to bring data to appropriate basal dendrites. The next pass of 3209 processes the basal dendrite signals as well as influence from 700 Astrocytes and potentially creates axon signals for the next 3209 update. The changing states of the neurons' somas, axons and basal dendrites are written back to 400. These changes are also passed to 3208 Update Astrocytes via 400 and 3208 also utilizes the last state of 700. Results from 3208 are written back to 700. Also, any axon signals produced by 3209 and recorded in 400 that are destined for either 3211 or 3201 are passed to 1506 which buffers the data into 1504 Output Buffers. Any such data from 1504 is passed to 3212 Actuators (e.g. artificial muscles, wheels, etc.) and to 3210 Internal Data; the latter passes data to 1505.

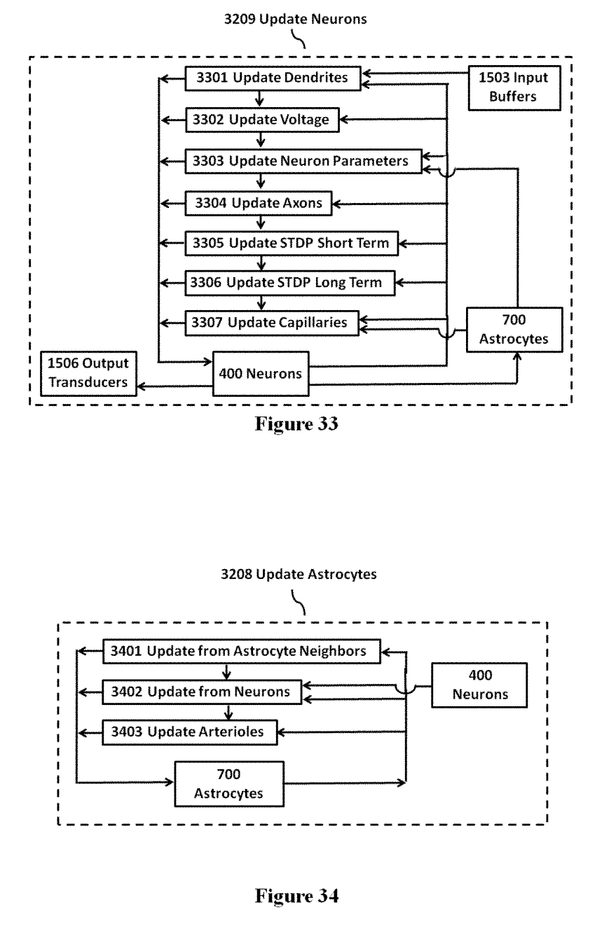

FIG. 33 illustrates expanded detail of FIG. 32's 3209 Update Neurons processes. 3209 begins with the first of two passes which constitute the 3209 process. As mentioned in the overview of FIG. 32, the first pass is to bring axon signals to all basal dendrites. This is accomplished by 3301 Update Basal Dendrites, which takes as its input axon signals from 400 Neurons Table 19 parameter 40010501 (for example and set from the second pass of the last cycle) or from 1503 Input Parameters 150301B (for example and set from the second pass of the last cycle). When all basal dendrites for all neurons have been updated (updated to new values or old values erased or no changes required) then the second pass of the cycle is entered as reflected by 3302 Update Voltage. The majority of neuron models a user might want to use, especially spiking models, include a voltage parameter. In 3302 the user incorporates their own calculations to establish the voltage, and likely the current of the neuron soma (Table 19 parameter 40010601, 40010602 for example). If the user has created multiple apical dendrites for this neuron then the voltage/current calculations are performed for each apical dendrite as well (Table 19 parameters 400104106 and 400104107 for example). The tool makes no assumptions and makes no requirements on a user's choice of potentially dozens of different voltage equations per apical dendrite and soma; the tool supports all such models. Next, 3303 Update Neuron Parameters is called to update the rest of the neuron model specific parameters (Table 19 parameters 40010606 to 40010608 and beyond for example). Again, the user has the flexibility to include whatever parameters make sense to their neuron model. Next, 3304 Update Axons is entered to do two things. The first is to copy forward the elements of the axon array by one element (to simulate an axon signal's progress from the soma to any given axon branch). For example, element n-1 is copied to element n, element n-2 is copied to element n-2, etc. The second is that if the computed neuron voltage in 3302 is sufficient, according to the user's neuron model, a 1 is written to element 0 of the axon array: Table 19 40010501. Next, 3305 Update STDP Short Term is called to calculate short term spike timing dependent plasticity (STDP). The short term dynamics are measured in tens to a few hundred milliseconds and reflect the axon's ability to recycle neurotransmitter to be ready for another spike event. Again, according to the user's neuron model short term STDP might be an important calculation else 3305 will be skipped. In this tool, a default equation is included for short-term STDP: −=(1−)/and → when the axon connected to these basal dendrites spikes. Here, x is the depression/potentiation scaling factor (Table 19 parameter 40010605) and recovers to 1 with a time course dictated by and is the value of the capillary resource at the neuron level (Table 19 parameter 40010603), is the decay (Table 19 parameter 40010604), and is a decay constant of the consumption of resources per spike. The results are written to Table 19 400104108A for example. Next, 3306 Update STDP Long Term is called to calculate long term spike timing dependent plasticity. Again, according to the user's neuron model long term STDP might be an important calculation else 3306 can be skipped. When included the results are written to Table 19 400104108B for example. In this tool, default equations are included for long-term STDP. In general, long-term STDP is a consequence of spike timing, which is to say, what is the correlation between an axon event (value of 1) and any consequent apical dendrite spike. The correlation can be positive where an axon event is followed in a narrow time window (20 ms) by a spike or the correlation can be negative where a spike is proceeded by an axon event within a narrow time window (20 ms). Positive correlations (long term potentiation (LTP)) are followed by a building out of the basal dendrites participating (which increases the conductance between the axon and basal dendrites) whereas negative correlations (long term depression (LTD)) are followed by a pruning of the basal dendrites participating (which decreases the conductance between the axon and basal dendrites). Toward this end the tool uses a concept of tagging, wherein the difference in nearest neighbor spike-timing pairs sets the maximum possible build out or pruning using both the tag and the availability of capillary resources (dictated by the CVU). The tag and capillary resources sets the build out or pruning rate; the higher the resources the greater the rate and conversely. For setting the tag, the closer in time the nearest neighbor spike pairs (axon event and basal dendrite response) the greater in magnitude is the tag (both positive and negative). The

$$tag = - {.5}^{4 Δ / 20} Δ < 0 ( L T D ) or tag = \frac{- 6 Δ}{20} Δ > 0 ( L T P ) .$$

Δ is the difference of the axon event minus the basal dendrite response (when it occurs) and the value “20” is in ms. Then the tag value is adjusted to account for the difference between the basal dendrite's conductance value and the calculated tag value. Basically, if the tag value is greater than the existing conductance then the tag is increased by the difference or if the tag value is less than the conductance then the tag is decreased by the difference. The resultant tag value is stored in Table 19 parameter 400104108F. In general, the ability of an axon to influence a basal dendrite is based on conductance (surface area of the basal dendrite). The conductance changes dynamically when the basal dendrites respond quickly (LTP) or if there is an anti-correlation (LTP). The tag sets up how the conductance will change and the resources supplied by the CVU maximize or minimize the possible change. In this tool conductance can vary from 0 to 1. Conductance defaults to 0.5. Every time step of the simulation (1 ms) either the tag is being set or reset or a build out/pruning is taking place after which the tag is decayed. Build out or pruning (Table 19 parameter 4001041086) takes place according to two equations. Biologically, these relationships are non-linear, however, in this tool that potentially implements a massive number of neurons as well as including the management of astrocytes (via the CVU) for STDP and tagging induced build out/pruning, the two equations have been linearized for efficiency. The first equation represents build out or pruning and takes place at a constant rate: =0.12* where positive values are for build out and negative values for pruning. The second equation represents the decay of the tag and it depends on both the initial tag value and the CVU resources present: =((1/)²+1.45(1/))+. When these two equations intersect build out/pruning terminates and the new strength is written out to 400104108B: either the intersected value is added to the old strength for LTP or subtracted for LTD. Finally, 3307 Update Capillaries is called to update the neuron's capillary resources as represented by which is Table 19 parameter 40010603. The capillary equation is sigmoidal and ranges from a minimum of 65% to a maximum of 120%: =1.3/(+0 85*e∧(−0.35*SpikeAccumulation)) where is the centriole supply (opening size of the centriole local to the basal dendrites' neuron) Table 19 parameter 40010603, is the centriole (arteriole) supply (opening size of the arteriole local to the neuron's astrocyte) Table 20 parameter 700105, and SpikeAccumulation is the number of spikes from the neuron Table 19 parameter 40010605. Parameter 700105 is discussed more fully in FIG. 34. Parameter 40010605 is added to for every neuron spike which occurs and when there are none then the parameter is decreased each processing cycle by 0.015. Any changes which result in axon spikes are written out to 1506 Output Transducers and written to 700 Astrocytes for astrocyte arteriole updates.

FIG. 34 illustrates expanded detail of FIG. 34, 3208 Update Astrocytes, showing the update astrocytes process. 3208 begins with 3401 Update from Astrocyte Neighbors. 3401 causes each astrocyte to query its connected astrocyte neighbors for their “release events” (Table 20 parameter 700107). A release event occurs when an astrocyte's soma value (Table 20 parameter 700104) reaches the level of 1 as detailed below; otherwise if 700104 is greater than 0 700104 is decayed by 0.001 times the current 700104 value. 3401 collects all of the 700107 values and equalizes the value by dividing by the number of astrocytes connected to. Next, 3402 Update from Neurons, is called to update the astrocyte soma value, 700104, according to its neurons surrounded. Each astrocyte soma's value is updated by 0.2 per any neuron soma spike (Table 19 parameter 400104108) for the neurons which the individual astrocyte surrounds (Table 20 parameter 700102) and if 700104 is greater than 0 and no spikes from neurons' surrounded have occurred then a decay is applied and 0.025 is subtracted from 700104; otherwise the total value is divided by the number of neurons surrounded. Then 3403 Update Arterioles is called to update the astrocyte's arteriole (Table 20 parameter 700105). The arteriole is the largest blood vessel of the NVU and it feeds the centrioles which in turn feed the neurons surrounded by the astrocyte and as such provides resources for the basal dendrites growth or pruning. The equation for calculating 700105 is: =1.3/(1.13+0.85*e∧(−0.35*Release)) where is 700105 and Release is 700107.

### REFERENCES

http://kaithinfo.com/nervous-system-classification-diagram-and-functions

http://neuroscience.uth.tmc.edu/s2/chapter01.html

https://en.wikipedia.org/wiki/Midbrain_tectum

http://www.britannica.com/science/midbrain

https://en.wikipedia.org/wiki/Pons

http://biology.about.com/od/anatomy/p/cerebellum.htm

http://www.3icreative.com/psych/hindbrain-myelencephalon-metencephalon.html

K. Brodmann, Localisation in the Cerebral Cortex, December 2005 ISBN: 978-0-387-26917-7 Defelipe, Javier (2012). “The neocortical column” Frontiers in Neuroanatomy 6.

doi:10.3389/fnana.2012.00022

Malcom Carpenter, Human Neuroanatomy, January 1996 |ISBN-10: 0683067524|ISBN-13: 978-0683067521

https://en.wikipedia.org/wiki/Cell_biology)

Raymond C. Koehler, Debebe Gebremedhin and David R. Harder (2005), “Role of astrocytes in cerebrovascular regulation”, J. Appl Physiol 100:307-31, 2006 .doi:10.1152/japplphysiol.00938.2005 Christian Giaume, Annette Koulakoff, Lisa Roux, David Holcman & Nathalie Rouach (2010), “Astroglial networks: a step further in neuroglial and gliovascular interactions”, Nature Reviews Neuroscience 11, 87-99 (1 Feb. 2010)1 doi:10.1038/nrn2757

http://www.ncbi.nlm.nih.gov/books/NBK53086/

Raymond C. Koehler, Debebe Gebremedhin and David R. Harder (2006), “Role of astrocytes in cerebrovascular regulation”, J. Appl Physiol 100:307-317, 2006. doi:10.1152/japplphysiol. 00938.2005

Grant R. J. Gordon, Clare Howarth and Brian A. MacVicar (2011), “Bidirectional control of arteriole diameter by astrocytes”, Exp Physiol 96.4 pp 393-399

A. Peters, and E. G. Jones, Cerebral Cortex, 1984

Daniel P. Buxhoeveden, Manuel F. Casanova (2002), “The minicolumn hypothesis in neuroscience”, Brain, awf110 935-951, 2002

Eugene M. Izhikevich (2004), “Which Model to Use for Cortical Spiking Neurons?”, IEEE Transactions on Neural Networks, VOL. 15, NO. 5, September 2004

Guo-qiang Bi and Mu-ming Poo (1998), “Synaptic Modifications in Cultured Hippocampal Neurons: Dependence on Spike Timing, Synaptic Strength, and Postsynaptic Cell Type”, The Journal of Neuroscience, Dec. 15, 1998, 18(24):10464-10472

Claudia Clopath., Lorric Ziegler., Eleni Vasilaki, Lars Bu\ddot{}sing, Wulfram Gerstner (2008), “Tag-Trigger-Consolidation: A Model of Early and Late Long-Term-Potentiation and Depression”, PLOS Computational Biology, December 2008 |Volume 4| Issue 12 | e1000248

What is claimed is:

1. A method of generating a computer implemented model of a nervous system, comprising: placing a small number of interconnected virtual neurons into numbered columns, and into distribution tables of increasing resolution wherein numbered columns are placed in a table of highest resolution, and into connection tables wherein the numbered columns may be joined, and neural vascular units which manage the growth and pruning of neuron synaptic processes.

2. The method of claim 1, further comprising a table of the numbered columns of step (a) wherein the types of neurons are identified.

3. The method of claim 2, further comprising a table of the operational parameters of the neurons of step (a).

4. The method of claim 2, further comprising the connections between the neurons within each numbered column of step (a).

5. The method of claim 2, further comprising the identity of layers within columns.

6. The method of claim 5, further comprising the identity of the location of the neurons from step (a) within the layers.

7. The method of claim 6, further comprising the identity of the location of the axon and the dendrite processes for those neurons within layers of claim 5.

8. The method of claim 1, further comprising the stacking of distribution tables for step (b) wherein three dimensional coordinates are assigned to each of the neurons.

9. The method of claim 1, further comprising the calculation of the length of the axon connections for step (c).

10. The method of claim 1, step (d) further comprising the placement of astrocytes within the neural vascular units.

11. The method of claim 10, wherein astrocytes are connected into networks.

12. The method of claim 1, step (d) further comprising the placement of capillaries within the neural vascular units.

13. The method of claim 1, step (d) and claim 7, further comprising the inclusion of dendrites within the neural vascular units.

14. The method of claim 1, wherein the nervous system model's operation is simulated.

15. The method of claim 14, further comprising parallel transfer of all axon signals for all neurons.

16. The method of claim 14, wherein dendrite activity is recorded in the form of a tag.

17. The method of claim 16, wherein tags indicate that dendrites should grow or be pruned.

18. The method claim 17, wherein growth or pruning is accelerated or decelerated by resources provided by capillaries of claim 12.

19. The method of claim 18, wherein capillary resources are managed by astrocytes of claim 10.

20. The method of claim 19, wherein astrocytes open or close capillary resources according to dendrite activity.

21. The method of claim 20, wherein astrocytes broadcast their activity through the astrocyte network of claim 11.

22. A method of simulating a nervous system, comprising:
defining columns containing cortical layers, having a dimension in accordance with a user's specification, that contain a collection of neurons of any type;
generating column definitions;
defining neuron connections within the columns;
defining first, second and third 2-dimensional grids, wherein each grid element of the second grid have a dimension smaller than each grid element of the first 2-dimensional grid, and wherein each of grid element of the third grid have a dimension smaller than grid elements of the second 2-dimensional grid;
assigning a unique identifier (ID) to each element in the second 2-dimensional grid and organizing the IDs in the first 2-dimensional grid;
assigning unique IDs to the grid elements of the third 2-dimensional grid, and organizing the IDs of the third grid under the second 2-dimensional grid;
assigning unique IDs to the column definitions and organizing the columns within the third 2-dimensional grid with one or more column IDs in each of the grid elements;
automatically assigning coordinates in the 2-dimensional grids and assigning a z coordinate of 0 for the first 2-dimensional grid;
if multiple first 2-dimensional grids are assigned, then assigning an increment along a z-axis for each additional third 2-dimensional grid.
